(19) United States
(12) Patent Application Publication
(10) Pub. No.: US 2026/0289116 A1
(43) Pub. Date: Sep. 24, 2026

(54) SYSTEM

(71) Applicant: SoftBank Group Corp., Tokyo (JP)

(72) Inventor: Yuya ONO, Tokyo (JP)

(73) Assignee: SoftBank Group Corp., Tokyo (JP)

(21) Appl. No.: 19/568,912

(22) Filed: Mar. 17, 2026

(30) Foreign Application Priority Data
Mar. 19, 2025 (JP) 2025-045107

(51) Int. Cl. G06F 40/268; G06N 3/0475

(52) U.S. Cl. CPC G06F 40/268; G06N 3/0475

(57) ABSTRACT

A system includes a processor that is configured to analyze a prompt sentence input by a user by using a generative AI model and process a prompt that instructs facilitation of dialogue between the user and an expert, acquire information from an external database and organize the information by using the generative AI model and process a prompt that instructs provision of the organized information to the user, and analyze text input of the user by using a natural language processing technique and process a prompt that instructs evaluation of an emotional state of the user.

### CROSS-REFERENCE TO RELATED APPLICATION

This application is based on and claims priority under 35 USC 119 from Japanese Patent Application No. 2025-045107 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems that support communication between users and experts in fields such as electricity and gas industries, energy management, or other technical domains generally rely on simple messaging functions and static retrieval of information from databases. In such systems, a processor typically forwards user inputs to experts or retrieves pre-stored information, without performing advanced interpretation or structuring of the user's intent. As a result, several problems arise.

First, the user's prompt sentence is often ambiguous or incomplete, and a conventional system cannot adequately interpret such prompts to facilitate a smooth and efficient dialogue with an expert. The burden of clarifying the problem and structuring the conversation remains largely on the user and the expert, which can lead to misunderstandings, increased interaction time, and reduced quality of advice.

Second, conventional systems generally provide information from external databases in a raw or only minimally processed form. The user must manually sift through large volumes of technical information, and the system cannot automatically organize, summarize, or adapt the information to the user's specific context by leveraging advanced generative AI capabilities. This results in inefficient information retrieval and poor usability, particularly for non-expert users.

Third, existing systems typically do not analyze the emotional state of the user based on natural language inputs. Consequently, the system cannot adapt its behavior to users who may be frustrated, anxious, or confused. For example, the system cannot provide additional guidance or adjust the level of detail and tone in responses according to the user's emotional condition, which can negatively affect user satisfaction and engagement.

Fourth, real-time routing of user prompts to experts and immediate return of expert responses are often not fully integrated with intelligent processing functions. Conventional architectures may support real-time chat, but they do not combine such real-time communication with generative AI analysis of prompts and user data, such as energy usage data, in a way that maximizes the value of expert advice.

In view of the above, there is a need for a system including a processor that can: (i) analyze user prompts by using a generative AI model to facilitate dialogue with experts; (ii) acquire and organize information from external databases by using the generative AI model and provide the organized information to the user; (iii) analyze user text input by using natural language processing techniques to evaluate the user's emotional state; (iv) transmit user prompts to experts in real time and return expert responses immediately; and (v) analyze user-specific data such as energy usage data by using a generative AI model to support high-quality expert advice. The present invention has been made in view of these problems.

### SUMMARY

To solve the above-described problems, a system according to one embodiment of the present invention comprises a processor, wherein the processor is configured to analyze a prompt sentence input by a user by using a generative AI model and process a prompt that instructs facilitation of dialogue between the user and an expert. By configuring the processor in this manner, the system interprets user inputs, disambiguates intent, and generates or processes internal prompts that guide the generative AI model to produce conversation structures, questions, or reformulations that make subsequent communication with the expert smoother and more efficient.

The processor is further configured to acquire information from an external database and organize the information by using the generative AI model and process a prompt that instructs provision of the organized information to the user. In this way, the system does not merely retrieve raw data from the external database, but automatically summarizes, classifies, and contextualizes the acquired information through the generative AI model, and thereby can present tailored and intelligible information to the user according to the user's needs and the context of the dialogue with the expert.

The processor is further configured to analyze text input of the user by using a natural language processing technique and process a prompt that instructs evaluation of an emotional state of the user. By incorporating natural language processing for emotion analysis, the system detects emotional cues in user text such as frustration, confusion, or urgency. The processor then processes prompts for emotional evaluation so that subsequent responses and interactions, including those involving the generative AI model and the expert, can be adapted in tone, detail, and pacing to better match the user's emotional state.

According to another aspect, the processor is configured to process a prompt that instructs transmission of the user's prompt to the expert in real time and immediate return of a response from the expert to the user. As a result, the system enables low-latency, interactive communication between the user and the expert, while at the same time leveraging the generative AI model and natural language processing functions described above. This integration allows the expert to receive prompts that are already analyzed or restructured, and enables the user to receive expert responses promptly.

According to still another aspect, the processor is configured to process a prompt that instructs analysis of energy usage data of the user by using the generative AI model and provision of advice from the expert to the user. In this configuration, the system applies the generative AI model to user-specific energy usage data (for example, electricity or gas consumption), identifies patterns, inefficiencies, or optimization opportunities, and presents such analysis as a basis for expert advice. The expert can then build upon the AI-assisted analysis to provide more precise, data-driven recommendations to the user.

By means of the above configurations, the system can: facilitate dialogue between users and experts through AI-assisted prompt analysis; provide organized and context-adapted information acquired from external databases; evaluate user emotional states and adapt interactions accordingly; provide real-time bidirectional communication with experts; and leverage generative AI analysis of user data such as energy usage to enhance the quality and relevance of expert advice. Consequently, the system effectively solves the problems inherent in conventional expert-support systems and improves both the efficiency and the user experience of expert consultation services.

The term “system” refers to an integrated combination of hardware and software components including at least one processor and associated memory and communication interfaces that cooperatively perform the functions described in the claims.

The term “processor” refers to one or more hardware processing units, such as a central processing unit (CPU), a graphics processing unit (GPU), a digital signal processor (DSP), or a combination thereof, configured to execute instructions and perform the data processing operations described in the claims.

The term “prompt sentence” refers to a natural language text input provided by a user, which expresses a request, question, instruction, or other intention to be processed by the system. The term “generative AI model” refers to a machine learning model, such as a large language model or similar neural network, that is trained to generate, transform, or analyze natural language text or other data based on learned patterns from training data.

The term “prompt” refers to data, including natural language instructions or structured control data, that is input to the generative AI model or processed by the processor to specify a desired operation, response, or behavior of the generative AI model or the system.

The term “facilitation of dialogue between the user and an expert” refers to improving or supporting the interaction between the user and the expert, including clarifying user intent, structuring questions, summarizing previous exchanges, or otherwise making the communication more efficient and understandable.

The term “external database” refers to a data storage system that is separate from and accessible by the system via a communication network or interface, and that stores information such as technical documents, manuals, records, or other reference data.

The term “organize the information” refers to processing acquired information to perform at least one of summarizing, classifying, reformatting, prioritizing, contextualizing, or otherwise restructuring the information so that it can be more easily understood and used by the user or expert.

The term “text input of the user” refers to any character-based input, including sentences, phrases, questions, or commands, that the user enters via a user interface such as a keyboard, touchscreen, or speech-to-text mechanism.

The term “natural language processing technique” refers to a computational method for analyzing, understanding, or generating human language, including techniques such as tokenization, parsing, sentiment analysis, intent recognition, or emotion detection.

The term “emotional state of the user” refers to a mental or affective condition of the user, such as frustration, satisfaction, confusion, anxiety, or confidence, inferred from the user's text input or other observable signals.

The term “transmission of the user's prompt to the expert in real time” refers to sending the user's prompt from the system to the expert with a delay that is sufficiently short to be perceived as substantially immediate by the user and the expert during an interactive communication session.

The term “immediate return of a response from the expert to the user” refers to transmitting a response generated by the expert from the system to the user without intentional delay after the response is received by the system, so that the user experiences the interaction as real-time or near real-time.

The term “energy usage data of the user” refers to data representing consumption or usage of energy resources by or for the user, such as electricity usage, gas usage, or other measurable energy-related parameters over time.

The term “advice from the expert” refers to guidance, recommendations, evaluations, or explanations provided by an expert to the user, which may be based on the expert's knowledge, the generative AI model's analysis, and the user's data including energy usage data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

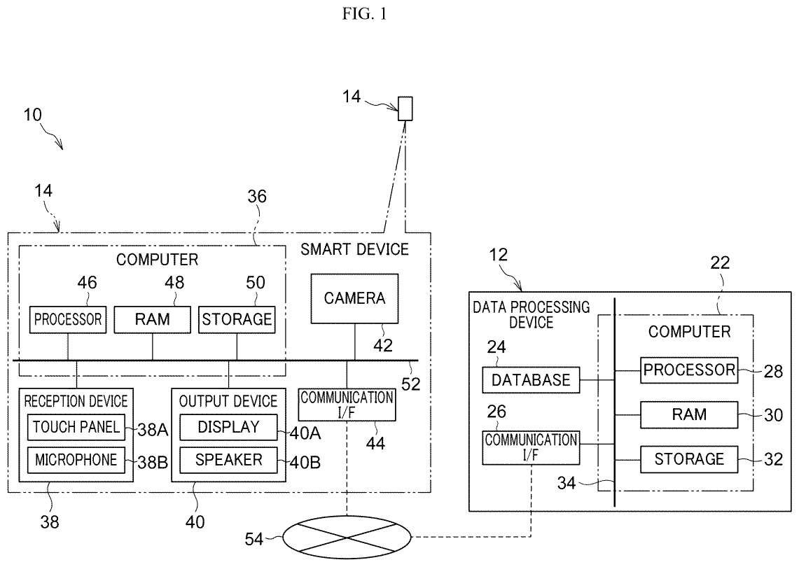

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

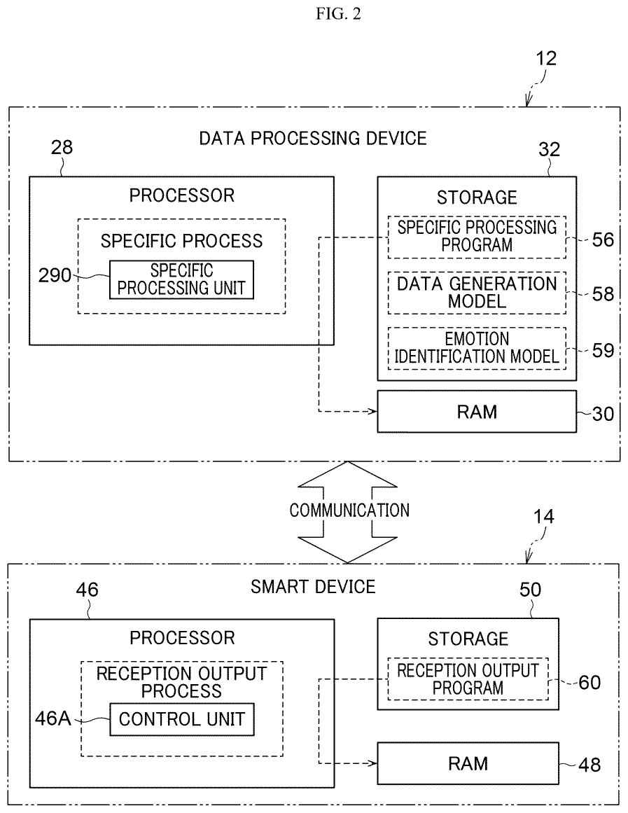

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional expert-user communication systems that operate over computer networks typically rely on simple message relays between user terminals and expert terminals. In such systems, a server generally forwards text messages without performing context-aware analysis, expert selection optimization, or dynamic integration of outputs from generative AI models. As a result, the following technical problems arise in terms of computer technology.

First, the server-side processing for routing user inquiries to experts is often implemented as static rule-based mapping that does not leverage natural-language content. The server does not perform fine-grained extraction of keyword information, topic information, or conversation identification information from natural-language prompt sentences. Consequently, the routing logic tends to be inefficient and inaccurate, leading to increased processing overhead on the server, suboptimal use of network resources, and delays in establishing suitable communication paths between user terminals and expert terminals.

Second, typical systems do not integrate generative AI models in a way that is tightly coupled with real-time communication and stored conversation history. In many cases, a generative AI model is invoked separately, without using structured prompt sentences that encode conversation context, expert answers, and user-specific conditions. This leads to redundant calls to the generative AI model, inconsistent supplemental information, and increased computational load on back-end processors. The absence of a standardized prompt-generation mechanism also makes it difficult to systematically improve the quality and stability of AI-generated supplemental information.

Third, known systems generally do not exploit log information related to message transmission and reception to adapt their internal expert selection logic and prompt-generation conditions. Without feedback from accumulated log information, the server cannot automatically optimize parameters such as expert selection conditions, communication patterns, or prompt structures. This results in a static system configuration that cannot effectively respond to variations in inquiry volume, user behavior, or model performance, thereby causing inefficiencies in processor utilization and network throughput.

Fourth, although some systems may attempt to estimate user emotion states, they usually do so in an ad hoc manner and do not integrate the estimated emotion-state information into the prompt sentences provided to a generative AI model. As a result, the system fails to adjust the content generated by the generative AI model according to the user's emotional context. This limitation prevents the server from generating adaptive supplemental information that can improve user comprehension and reduce unnecessary follow-up communication, thereby increasing overall computational and communication load.

Fifth, with respect to domain-specific data such as energy usage situation data, existing systems either analyze such data separately or rely solely on expert interpretation. They do not systematically combine sensor or usage data, historical expert advice, and prior AI-generated supplemental information into a single, structured prompt to a generative AI model. This fragmented processing leads to duplicated analysis, inconsistent recommendations, and inefficient utilization of computing resources on the server.

Accordingly, there is a need for a computer-implemented system that improves server-side processing by: (i) extracting structured information from natural-language prompt sentences; (ii) dynamically selecting experts based on natural-language processing; (iii) establishing and managing real-time communication paths between user terminals and expert terminals; (iv) generating optimized, context-rich prompt sentences for generative AI models; (v) using log information to adapt expert selection conditions and prompt-generation conditions; and (vi) integrating emotion-state information and domain-specific data into the generative AI model input. Such a system would improve the technical performance of the underlying computer infrastructure, including processing efficiency, scalability, and quality of generated supplemental information.

The specific processing by the specific processing unit 290 of the data processing device 12 in Example 1 is realized by the following means.

The present invention provides a server comprising a processor and a data storage device, the processor being configured to receive, from a user terminal, a natural-language prompt sentence, analyze the prompt sentence to extract user identification information, conversation identification information, and text information corresponding to inquiry content, and store the text information in the data storage device; apply natural language processing to the text information to extract keyword information and topic information, search the data storage device storing expert information based on the keyword information and the topic information, and identify an expert related to the inquiry content; establish, between the user terminal and an expert terminal of the identified expert, a communication path that enables real-time transmission and reception of message information, transmit inquiry text information acquired from the user terminal to the expert terminal, and transmit answer text information acquired from the expert terminal to the user terminal without delay; generate a prompt sentence based on the answer text information acquired from the expert terminal and conversation history information related to the answer text information, input the prompt sentence into a generative AI model, and cause the generative AI model to generate supplemental information that complements the answer text information; store, in association with the conversation identification information, the supplemental information output from the generative AI model in the data storage device, and transmit the supplemental information to the user terminal so that the supplemental information is displayed together with the answer text information; acquire log information regarding transmission and reception processing of the message information and the supplemental information between the user terminal and the expert terminal, and update an expert selection condition and a prompt sentence generation condition based on the log information; analyze, by using natural language processing, emotion-state estimation text information acquired from the user terminal to estimate emotion-state information, and add conversation-context information including the emotion-state information to the prompt sentence input into the generative AI model so as to cause the generative AI model to generate the supplemental information in accordance with a user emotion state; and include energy usage situation data, past expert answer history data, and past supplemental information data in the prompt sentence input into the generative AI model, and cause the generative AI model to generate, as the supplemental information, energy-saving action proposal information that integrates an analysis result based on the energy usage situation data and advice from the expert. This enables improved utilization of computing and storage resources by the server, adaptive optimization of expert selection and prompt generation based on accumulated log information, context-aware generation of supplemental content by the generative AI model that reflects conversation history, emotion state, and domain-specific data, and enhanced efficiency and reliability of real-time expert-user communication executed by the underlying computer system.

The term “system” refers to an arrangement of hardware and software components including at least one processor and at least one memory or data storage device, configured to execute programmed instructions to perform the claimed functions.

The term “processor” refers to one or more hardware processing units, such as a central processing unit or a graphics processing unit, capable of executing machine-readable instructions to perform logical, arithmetic, and control operations.

The term “data storage device” refers to one or more non-transitory computer-readable media, such as semiconductor memory, magnetic storage, or optical storage, that store data, program code, and models used by the processor.

The term “user terminal” refers to an electronic apparatus operated by a user, such as a general-purpose computing device or a portable communication device, that is configured to transmit data to, and receive data from, the system via a communication network.

The term “expert terminal” refers to an electronic apparatus operated by an expert, such as a general-purpose computing device or a portable communication device, that is configured to transmit data to, and receive data from, the system via a communication network.

The term “natural-language prompt sentence” refers to text data expressed in a human language that is input by a user or generated by the system and that is used as an instruction or query to control processing by a generative AI model or other natural language processing component.

The term “user identification information” refers to data that uniquely or pseudo-uniquely identifies a user within the system, such as an account identifier, session identifier, or other user-related identifier.

The term “conversation identification information” refers to data that associates a plurality of messages or interactions with a single conversation instance, such as a conversation identifier or thread identifier.

The term “text information” refers to character-based digital data representing natural-language content, including questions, answers, comments, and other message content.

The term “inquiry content” refers to the substantive subject matter or issue indicated by text information submitted by a user, which forms the basis of a question or request directed to the expert.

The term “natural language processing” refers to computer-implemented techniques for processing human language text, including at least one of tokenization, morphological analysis, syntactic analysis, semantic analysis, keyword extraction, topic classification, and sentiment analysis.

The term “keyword information” refers to one or more terms or expressions extracted from text information that represent important concepts, entities, or attributes relevant to the inquiry content.

The term “topic information” refers to data indicating a subject category, domain, or theme inferred from text information, used for classification, routing, or matching of messages within the system.

The term “expert information” refers to data stored in the data storage device that describes characteristics of an expert, including at least one of expertise domain, skill tags, availability status, and historical performance indicators.

The term “expert selection condition” refers to one or more criteria or rules used by the processor to select or prioritize an expert for handling a particular inquiry, based on expert information, keyword information, topic information, or log information.

The term “communication path” refers to a logical or physical channel established over a communication network that enables bidirectional, real-time or near real-time transmission and reception of message information between terminals and the system.

The term “message information” refers to structured data representing communication units such as user questions, expert answers, system notifications, or AI-generated supplemental information, including associated metadata such as identifiers and timestamps.

The term “inquiry text information” refers to text information included in a message that originates from a user and expresses a question, request, or problem to be addressed by the expert or the system.

The term “answer text information” refers to text information included in a message that originates from an expert or from the system and provides a response, explanation, or recommendation with respect to inquiry text information.

The term “conversation history information” refers to accumulated data representing past messages, interactions, and events in a conversation, including text information, timestamps, and associated metadata.

The term “prompt sentence” refers to structured text constructed by the processor, including at least part of conversation history information, answer text information, and optional context information, and used as input to a generative AI model to control the generation of output content.

The term “generative AI model” refers to a machine learning model, such as a neural-network-based language model, trained on data to generate text or other content in response to input, including at least a prompt sentence.

The term “supplemental information” refers to content generated by the generative AI model that is intended to complement, elaborate, or clarify answer text information provided by an expert or the system.

The term “prompt sentence generation condition” refers to one or more parameters, rules, or templates used by the processor to determine how to construct a prompt sentence, including selection of included fields, formatting, and context depth.

The term “log information” refers to data recording events and parameters related to transmission, reception, processing, and generation of message information and supplemental information, including timestamps, identifiers, and processing results.

The term “emotion-state estimation text information” refers to text information obtained from user messages or related inputs that is analyzed to infer an emotional condition of the user, such as satisfaction, frustration, or anxiety.

The term “emotion-state information” refers to data indicating an inferred emotional condition of a user, derived from emotion-state estimation text information using natural language processing techniques.

The term “conversation-context information” refers to data representing the state of an ongoing conversation, including at least part of conversation history information, emotion-state information, and other context used to control generative processing.

The term “energy usage situation data” refers to data representing consumption of energy resources, such as time-series usage values, device-level usage, or aggregated consumption metrics for a facility or user.

The term “past expert answer history data” refers to stored records of answer text information previously provided by one or more experts, together with associated metadata such as topics, timestamps, and outcomes.

The term “past supplemental information data” refers to stored records of supplemental information previously generated by the generative AI model, including associated topics, conversation identifiers, and timestamps.

The term “energy-saving action proposal information” refers to supplemental information that includes one or more recommended actions or plans for reducing energy consumption, generated by integrating analysis of energy usage situation data with expert advice.

In one embodiment, a server operates as a network-accessible information processing apparatus that coordinates communication between a user terminal and an expert terminal and interacts with a generative AI model. The server includes at least one processor, such as a multi-core central processing unit and optionally a graphics processing unit, and at least one non-transitory memory and data storage device, such as semiconductor memory and magnetic storage. The server executes server-side application software implemented, for example, using an operating system such as a generic server operating system, a runtime environment such as a server-side scripting platform or an application framework, and database middleware such as a relational database management system or a document-oriented database system.

The server stores user identification information, expert information, message information, conversation identification information, and log information in one or more data structures. In one example, the server manages a “users” table or collection including fields for user identifiers, roles, and preferences; an “experts” table or collection including fields for expert identifiers, expertise tags, and availability status; a “conversations” table or collection including fields for conversation identifiers, user identifiers, expert identifiers, and timestamps; and a “messages” table or collection including fields for message identifiers, conversation identifiers, sender identifiers, message types, and text information. The server further stores a “logs” data structure including fields for event type, timestamps, communication path identifiers, and processing results.

The terminal functions as a client device implemented, for example, as a personal computer, a tablet device, or a smartphone. The terminal executes a web browser or a native application and communicates with the server via a packet-based communication network using protocols such as Hypertext Transfer Protocol Secure and a bidirectional communication protocol. The terminal presents a user interface including input fields for natural-language prompt sentences and display areas for messages, expert answers, and supplemental information generated by the generative AI model.

The user operates the terminal to input inquiry content in the form of a natural-language prompt sentence. The terminal generates structured request data including at least user identification information, conversation identification information, and the prompt sentence, and transmits this request data to the server. The server receives the prompt sentence and applies natural language processing to the text information. In one embodiment, the server tokenizes the text into subword units, normalizes tokens using lowercasing and stemming, and then applies a topic classification model to obtain topic information. The server also extracts keyword information using a statistical keyword extraction algorithm that computes term frequency-inverse document frequency scores over a domain-specific corpus stored in the data storage device.

The server uses the keyword information and topic information as features to search the expert information stored in the data storage device. In one example, the server computes a similarity score between a vector representation of the inquiry content and vector representations of experts' expertise tags. The server represents each expert's expertise tags as a vector in an embedding space and represents the inquiry content by averaging or weighting embedding vectors of extracted keywords. The server selects an expert whose expertise vector has a cosine similarity greater than a predetermined threshold, thereby improving the accuracy of expert selection compared to simple rule-based mapping.

The server establishes a communication path between the user terminal and the expert terminal upon selecting the expert. The server maintains a connection registry in memory that maps active session identifiers to underlying connections and conversation identifiers. The server associates the conversation identification information with both the user terminal and the expert terminal and uses this mapping to route message information. By maintaining this mapping in memory and indexing it by conversation identifiers, the server reduces lookup time for route resolution and enables low-latency message passing.

The expert operates the expert terminal to review inquiry text information and to input answer text information. The terminal displays the inquiry text information with associated metadata such as the conversation identification information and timestamps. The expert terminal transmits answer text information to the server using the established communication path. The server stores the answer text information in the messages data structure and links it to the corresponding conversation identification information, thereby maintaining conversation history information.

The server generates a prompt sentence for the generative AI model based on the answer text information and the conversation history information. In one embodiment, the server constructs the prompt sentence using a template that concatenates: (i) a role instruction, (ii) a summary of the user's inquiry text information, (iii) the expert's answer text information, and (iv) optional context such as user emotion-state information and energy usage situation data. Examples of such prompt sentences include:

“You are an energy-efficiency consultant. The user asked: ‘How can I improve energy efficiency at home during winter?’ The expert answered: ‘You can reduce energy consumption by sealing window gaps, improving insulation, and lowering your thermostat by 1-2 degrees.’ Provide additional, practical advice, including at least three more suggestions, and explain them in simple terms.”

“The user wants a 1-month step-by-step plan to reduce gas usage at home. Previous expert advice: ‘Seal window gaps, improve insulation, lower thermostat by 1-2 degrees.’ Previous AI supplement: ‘Use programmable thermostats, heavy curtains, and regular maintenance.’ Create a weekly plan for 4 weeks, with simple tasks for each week.”

“You are an expert in electricity and gas usage. The user asked: ‘How can I reduce my electricity bill without replacing major appliances?’ Provide 5 concrete actions, ordered by impact, and explain why each action is effective.”

The server supplies the constructed prompt sentence to a generative AI model. In one embodiment, the generative AI model is implemented as a transformer-based neural network including an embedding layer, multiple self-attention layers, feed-forward layers, and a softmax output layer. The server encodes the prompt sentence into a sequence of token identifiers using a subword tokenizer. These token identifiers are processed by the generative AI model, which computes contextualized vector representations through multi-head attention and feed-forward transformations. The server configures generation parameters such as maximum output length, sampling temperature, and top-k or top-p sampling thresholds. The generative AI model outputs a sequence of token probabilities that the server decodes into supplemental information.

The server executes a training process for the generative AI model on a separate training infrastructure before deployment or updates the model periodically. In one embodiment, the server uses supervised learning with a loss function such as cross-entropy over target token sequences. The server updates model parameters using stochastic gradient descent or a variant such as Adam, with backpropagation applied across the transformer layers. The server may apply data augmentation techniques, such as paraphrasing and synonym substitution, to expand the training corpus in domains relevant to energy efficiency and expert-user communication. By using such training methods, the server improves the model's ability to generate contextually appropriate and domain-consistent supplemental information.

The server processes the generated supplemental information with post-processing rules. The server filters out sequences that contain tokens corresponding to disallowed content categories and truncates overly long outputs to a maximum character length to maintain response time. The server tags the supplemental information with metadata fields including generation time, model version identifier, and related conversation identification information. The server stores the supplemental information in the data storage device and transmits the supplemental information to the user terminal.

The terminal displays the supplemental information to the user together with the expert's answer text information. The terminal visually distinguishes the supplemental information from expert responses, for example, by applying different color schemes or labels. The user can read the combined content and may issue follow-up prompt sentences through the same interface, thereby providing additional emotion-state estimation text information and updated inquiry content.

The server processes emotion-state estimation text information by applying a sentiment analysis model. In one embodiment, the server uses a classifier built on top of a language encoder that outputs a probability distribution over emotion categories. The server derives emotion-state information by selecting the emotion category with highest probability or by thresholding probabilities over multiple categories. The server includes the emotion-state information in conversation-context information and appends this information to the prompt sentence with explicit instructions, such as: “The user seems frustrated. Provide a calm and reassuring explanation.” By embedding emotion-state information in this structured way, the server causes the generative AI model to adjust its output style, which reduces repeated follow-up queries and lowers communication load.

The server acquires log information related to each transmission and reception of message information and supplemental information. The server records, for each event, timestamp data, latency values, chosen expert identifiers, prompt sentence templates used, and model output length. The server periodically analyzes this log information using statistical aggregation and pattern mining. The server updates expert selection conditions, for example by increasing weights for experts whose historical responses exhibit lower conversation length and higher user satisfaction scores stored as part of the log information. The server updates prompt sentence generation conditions, for example by modifying template structures or adjusting maximum context length to balance computational load and output relevance. These adaptive updates improve system performance in terms of processing efficiency and answer quality.

The server integrates domain-specific data such as energy usage situation data into the prompt sentence when available. The server retrieves energy usage situation data from a sensor data storage module, where data is stored as time-series values for different measurement points. The server aggregates the time-series data into features such as daily averages, peak demand, and variability indices. The server formats these features into human-readable summaries or structured descriptions embedded in the prompt sentence, for example: “The user's average daily electricity usage is 25 kWh, with peak consumption between 18:00 and 21:00.” The generative AI model uses these features, together with expert answer history and past supplemental information, to generate energy-saving action proposal information tailored to the underlying data. As a result, the system performs a combined data-driven and expert-driven analysis that would be impractical to perform manually in real time. The server improves computer technology in several ways. By extracting structured keyword information and topic information from natural-language prompt sentences and using vector-based similarity search, the server reduces the need for complex, manually configured rule sets, thereby lowering maintenance costs and improving scalability. By maintaining conversation identification information and connection mappings in memory and routing messages based on these identifiers, the server reduces routing overhead and achieves lower latency compared to conventional broadcast or polling mechanisms. By integrating log-based feedback into expert selection and prompt sentence generation, the server continuously optimizes internal parameters, which reduces average response time and improves prediction accuracy of expert matching.

The server further improves computational efficiency when interfacing with the generative AI model. By constructing prompt sentences that include only relevant portions of conversation history information and selected features such as emotion-state information and energy usage situation data, the server reduces the length of the input sequence to the generative AI model without degrading semantic completeness. This reduction in sequence length directly decreases the number of attention computations, thereby reducing processing time and resource usage on the underlying hardware. Furthermore, by sharing trained model parameters across multiple conversations and reusing cached representations of frequently used instructions in the prompt sentence, the server avoids redundant computation and further improves throughput.

The server executes processing steps that are not mere automation of human judgment. The server applies algorithmic transformations such as tokenization, embedding, vector similarity computation, attention-based sequence modeling, and log-based parameter adjustment that rely on internal numerical states and matrix operations. These operations depend on the structured data representation and model architecture, and they cannot be replicated by a human expert at comparable speed or scale. The combination of these computational procedures and the controlled interaction with the generative AI model results in improved accuracy of expert selection, improved contextual relevance of supplemental information, and reduced network and processor load.

In alternative embodiments, the server may use different natural language processing libraries or different neural network architectures, such as recurrent neural networks or convolutional sequence models, while preserving the same overall data flow and functional roles. The server may deploy the generative AI model locally or access it through an external inference service. The server may store conversation history information and log information in various data structures, such as graph databases or key-value stores, to optimize specific query patterns. The server may also adapt the domain from energy efficiency to other technical fields, such as medical guidance, industrial equipment maintenance, or transportation optimization, while using the same principles of expert selection, context-aware prompt sentence generation, and model-based supplemental information generation.

In a further embodiment, the terminal may run a lightweight emotion-state estimation model locally, transmitting only summarized emotion-state information to the server. The server may then refine this information and integrate it into conversation-context information for the generative AI model. In another embodiment, the server may allocate conversations to multiple experts and synthesize multiple expert answer text information entries into a consolidated context for the generative AI model, allowing the system to generate supplemental information that resolves conflicting advice and explains trade-offs to the user. By defining clear data structures, specific neural network architectures and training procedures, and concrete algorithms for expert selection, prompt sentence generation, and log-based adaptation, the system achieves technical effects that include improved processing speed, improved accuracy of content routing and generation, reduced computational and communication overhead, and enhanced robustness of the expert-user communication platform executed by the server.

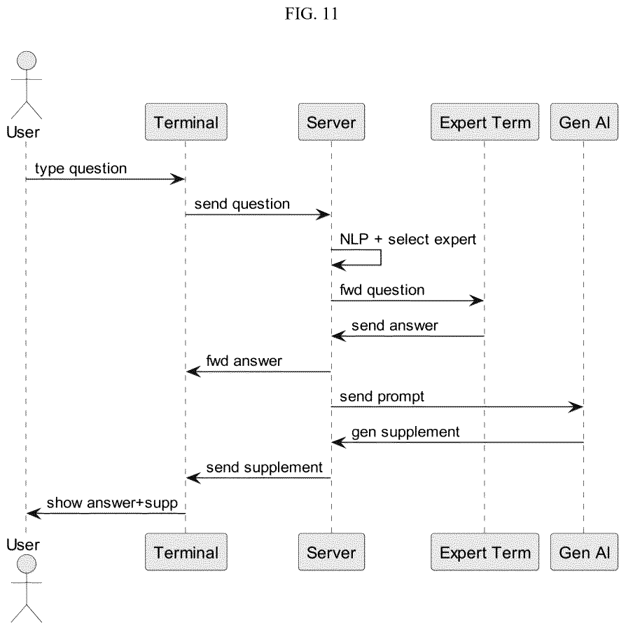

The following describes the processing flow using FIG. 11.

### Step 1:

User operates the terminal to access a chat interface and inputs an inquiry in natural language, for example, “How can I improve energy efficiency at home during winter?”. The terminal receives the keystrokes, composes a text string, and when the user presses a send button, the terminal generates a request object containing user identification information, optional conversation identification information, and the input text as a prompt sentence. As input, the terminal uses user interaction events and previously stored identifiers; as output, the terminal produces a structured request object. The terminal transmits this request object to the server over a network connection using a communication protocol.

### Step 2:

Server receives the request object from the terminal and validates its structure. As input, the server uses the request object containing fields such as user identification information and prompt sentence text. Server checks for missing fields, invalid identifiers, and excessive length, and if the object is valid, the server stores the original prompt sentence and associated metadata in a data storage device as a new message record. As output, the server produces a normalized internal representation of the inquiry text and a stored record identifier.

### Step 3:

Server performs natural language preprocessing on the inquiry text. As input, the server uses the normalized inquiry text from Step 2. Server tokenizes the text into tokens, normalizes tokens by lowercasing and stemming, and removes stop words. Server then computes keyword information by calculating term frequency-inverse document frequency values for remaining tokens using precomputed corpus statistics stored in the data storage device. As output, the server produces a list of keyword tokens with associated weights and a cleaned text representation.

### Step 4:

Server computes topic information for the inquiry text. As input, the server uses the cleaned text representation from Step 3. Server applies a topic classification model, for example a trained neural network or a probabilistic classifier, to calculate probabilities for a predefined set of topic labels. Server selects one or more topic labels whose probabilities exceed a threshold and records these labels as topic information. As output, the server produces a set of topic labels and associated confidence scores.

### Step 5:

Server identifies a suitable expert based on keyword information and topic information. As input, the server uses the keyword list with weights and the topic labels from Steps 3 and 4, and expert information stored in the data storage device. Server represents each expert's expertise tags as a numeric vector in an embedding space, represents the inquiry as a numeric vector derived from keywords, and computes similarity scores, for example cosine similarity, between the inquiry vector and each expert vector. Server filters experts by topic labels and then ranks them by similarity score and availability. As output, the server selects one expert identifier and stores an association between the conversation identification information and the expert identifier.

### Step 6:

Server establishes a communication path between the user terminal and the expert terminal. As input, the server uses the selected expert identifier and the conversation identification information from Step 5 and active connection information stored in memory. Server looks up an existing connection entry for the expert terminal, or initializes a new communication session if needed, and registers a mapping from the conversation identification information to both the user terminal connection and the expert terminal connection. As output, the server produces updated connection mapping data and a ready communication path for message routing.

### Step 7:

Server forwards the inquiry text to the expert terminal. As input, the server uses the conversation identification information, the inquiry text, and the connection mapping from Step 6. Server constructs a message object including the inquiry text, user identification information, and timestamps, and sends this message object through the communication path to the expert terminal. As output, the server produces a transmitted message event and log information recording that the message has been routed to the expert.

### Step 8:

Terminal of the expert receives the forwarded inquiry and displays it. As input, the expert terminal uses the message object received from the server. The terminal parses the message object, extracts the inquiry text, user name or identifier, and timestamp, and updates a chat display area to present the inquiry. As output, the terminal produces a visual representation of the inquiry on a display device and an internal state indicating that this conversation is active.

### Step 9:

Expert operates the expert terminal to input an answer. As input, the expert terminal uses the visualized inquiry and conversation state. The expert types a natural-language answer, such as “You can reduce energy consumption by sealing window gaps, improving insulation, and lowering your thermostat by 1-2 degrees.” The terminal captures the text, associates it with expert identification information and the conversation identification information, and packages it into an answer message object. As output, the terminal produces a structured answer message ready for transmission to the server.

### Step 10:

Terminal of the expert sends the answer message to the server. As input, the terminal uses the answer message object created in Step 9. The terminal uses the established communication path to transmit the message object over the network. As output, the terminal produces a network transmission containing the answer text and metadata.

### Step 11:

Server receives the expert's answer and stores it. As input, the server uses the answer message object arriving from the expert terminal. Server validates conversation identification information and expert identification information, then writes the answer text and associated metadata as a new record in the messages data structure, linking it to the existing conversation. As output, the server produces an updated conversation history and a persistent identifier for the stored answer.

### Step 12:

Server forwards the expert's answer to the user terminal. As input, the server uses the stored answer text and the connection mapping for the conversation from Step 6. Server constructs a response object including the answer text, expert identification information, and timestamps, and routes this object to the user terminal via the communication path. As output, the server generates a transmitted response event and log information for delivery to the user.

### Step 13:

Terminal of the user receives the expert answer and displays it. As input, the user terminal uses the response object sent by the server. The terminal parses the response, extracts the answer text and metadata, and renders the answer beneath the original inquiry in the chat interface, optionally with a label indicating that this is an expert answer. As output, the terminal produces a visual display allowing the user to read the expert's response.

### Step 14:

Server analyzes conversation history and emotion-state estimation text information. As input, the server uses the conversation history information accumulated in the data storage device and the latest user messages, including any expressions that indicate emotional state. Server applies a sentiment analysis or emotion classification model to the user text, computing probabilities for emotion categories such as “neutral,” “confused,” or “frustrated.” Server selects one or more categories based on these probabilities and records emotion-state information along with the conversation. As output, the server produces updated conversation-context information including emotion-state information.

### Step 15:

Server retrieves domain-specific data and past model outputs. As input, the server uses the conversation identification information and user identification information. Server queries the data storage device for energy usage situation data, past expert answer history data, and past supplemental information data related to the same user or conversation. Server aggregates and formats these data into structured summaries, such as daily average energy usage or brief text summaries of previous advice. As output, the server generates a context package that contains domain-specific features and historical content.

### Step 16:

Server constructs a prompt sentence for the generative AI model. As input, the server uses the expert's latest answer text, the conversation history information, the emotion-state information from Step 14, and the context package from Step 15. Server applies a prompt-generation rule set or template that concatenates a role instruction, a restatement of the user question, the expert's answer, any relevant domain summaries, and an explicit instruction for the generative AI model. For example, the server may construct the prompt sentence: “Act as an energy-efficiency consultant. The user asked: ‘How can I improve energy efficiency at home during winter?’ The expert answered: ‘You can reduce energy consumption by sealing window gaps, improving insulation, and lowering your thermostat by 1-2 degrees.’ The user seems frustrated. Provide additional, practical advice, including at least three more suggestions, and explain them in simple terms.” As output, the server produces a single textual prompt sentence ready for model input.

### Step 17:

Server encodes the prompt sentence and sends it to the generative AI model. As input, the server uses the constructed prompt sentence from Step 16. Server applies a tokenizer to convert the text into a sequence of token identifiers and assembles a model input structure including model parameters such as maximum length and sampling controls. The server transmits this structure to a generative AI model endpoint, either locally hosted or remote, using a communication protocol such as an application programming interface call. As output, the server produces an inference request that the generative AI model can process.

### Step 18:

Server receives generated supplemental information from the generative AI model. As input, the server uses the model output, which consists of a sequence of token identifiers or characters representing generated text. Server decodes token identifiers back into a natural-language text string and may apply post-processing steps such as removing trailing incomplete sentences, enforcing length limits, and filtering inappropriate content. As output, the server produces a finalized supplemental information text string associated with the conversation.

### Step 19:

Server stores supplemental information and updates logs. As input, the server uses the supplemental information text from Step 18 and the conversation identification information. Server writes a new record to the messages or supplemental information data structure, linking this record to the conversation and including metadata such as model version, generation time, and any prompt-related parameters. Server also appends a new entry to the logs data structure recording parameters such as input length, output length, processing time, and routing decisions. As output, the server produces an updated persistent conversation history and log information.

### Step 20:

Server transmits supplemental information to the user terminal. As input, the server uses the stored supplemental information and the connection mapping for the conversation. Server constructs a display message that includes the supplemental information text and a label indicating that the content is generated by a generative AI model. The server sends this message through the communication path to the user terminal. As output, the server generates a network transmission that delivers AI-generated supplemental information to the user.

### Step 21:

Terminal of the user receives and displays the supplemental information. As input, the terminal uses the message from Step 20. The terminal parses the message, extracts the supplemental information text, and inserts it into the chat interface near the corresponding expert answer, with a visual distinction to indicate that it is an AI supplement. As output, the terminal produces an updated screen showing both expert and AI-generated content.

### Step 22:

Server periodically analyzes accumulated log information to optimize expert selection and prompt generation. As input, the server uses log entries containing data such as message counts, response times, model call frequencies, user satisfaction indicators, and topic distributions. Server performs statistical aggregation, such as computing average response times per expert and per topic, and applies optimization rules to adjust expert selection conditions and prompt sentence generation conditions. For example, the server may update weights used in similarity calculations or adjust the amount of conversation history included in prompt sentences. As output, the server produces updated configuration parameters stored in the data storage device and loaded into runtime memory, thereby influencing subsequent routing and prompt-generation behavior.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems for energy management and expert consultation primarily function as static dashboards or simple messaging tools. In many cases, a server merely collects measurement data from field devices, stores the data in a database, and displays graphs or threshold-based alerts to a user terminal. When expert advice is required, the system typically forwards user messages to a human specialist and returns the specialist's reply without any deep integration between numerical analysis, natural language processing, and conversational control. As a result, several technical problems arise in the operation of such systems.

First, the server-side processing pipeline generally treats time-series energy usage data and natural language dialogue data as separate streams. The server does not continuously correlate sensor-derived metrics, such as abnormal increases in energy consumption, with conversational context or prompt sentences used for interaction with a generative AI model. This separation leads to inefficient use of computing resources, because the processor must repeatedly perform ad hoc data retrievals and reconstructions of context for each expert consultation. It also results in increased latency between anomaly detection and the generation of tailored, context-aware guidance to the user.

Second, known systems lack a structured mechanism in the processor for dynamically generating and managing prompt sentences for a generative AI model based on machine-readable analysis results. Typically, a generative AI model is invoked using generic or manually crafted prompts that do not systematically encode the anomaly characterization, historical baseline information, domain constraints, and dialogue policy. This causes unstable output quality, redundant computation for repeated or similar anomalies, and difficulty in maintaining predictable behavior of the model across different users and facilities.

Furthermore, the absence of integrated control prompts makes it hard to adapt the generative AI model to the role of a domain-specific assistant that can maintain dialogue coherence over time.

Third, existing systems do not effectively close the feedback loop between user-implemented actions and the computational models used for future analysis and prompt generation. When a user implements recommended measures, such as adjusting equipment schedules, the server typically records this information, if at all, in a loosely coupled log that is not systematically associated with the original AI-generated advice and the subsequent change in sensor data. Consequently, the processor is unable to refine future analysis logic, prompt templates, or model instructions based on the actual effectiveness of prior recommendations, leading to suboptimal use of storage structures and computational capabilities over the lifecycle of the system.

Fourth, known architectures treat expert communication and AI-generated responses as parallel, but independent, channels. The server relays messages between a user terminal and an expert terminal, and separately generates AI-based suggestions, without a unified mechanism for integrating and managing these multiple sources of responses at the processor level. This results in fragmented conversation histories, inconsistent advice presentation, and increased processing overhead for synchronizing displays across terminals. The lack of a unified conversation support structure impairs the ability of the processor to manage dialogue history as a coherent data object that can be efficiently reused by the generative AI model and by the expert.

Accordingly, there is a need for a technical solution that improves computer technology by providing, at the processor level, an integrated mechanism for (i) anomaly detection over energy usage information, (ii) automatic construction and control of prompt sentences and control prompts for a generative AI model, (iii) unified management of dialogue history involving both AI-generated responses and specialist responses, and (iv) adaptive updating of future prompts and model instructions based on user implementation status and subsequent sensor data. Such a solution should reduce computational redundancy, lower end-to-end response time, and enhance the reliability and consistency of AI-assisted expert consultation in a networked environment including user terminals and specialist terminals.

The specific processing by the specific processing unit 290 of the data processing device 12 in Application Example 1 is realized by the following means.

The present invention provides a server comprising a processor and a storage device, the processor being configured to store energy usage information received from a user terminal in association with historical information in the storage device, execute aggregation processing and statistical processing based on time-series information and attribute information, determine an abnormal state of energy usage by comparing a reference value and a current value, generate analysis result information including identification information, time range information, energy usage increase ratio information, and equipment type information when the abnormal state is determined, generate a prompt sentence from the analysis result information, input the prompt sentence and the analysis result information to a generative AI model to cause the generative AI model to generate advice information on energy management in natural language, add a control prompt sentence including domain information and conversation policy information to the generative AI model to set dialogue generation conditions, generate conversation support information configured to facilitate a dialogue between a user and a specialist by storing the advice information on energy management together with dialogue history information, cause a notification of the abnormal state of energy usage to be provided to the user terminal using the advice information on energy management and the conversation support information, output control information for launching a dialogue screen with the specialist from the notification, provide to the generative AI model text information including a prompt sentence input from the user terminal and the dialogue history information to cause the generative AI model to generate a response sentence and, as necessary, relay the text information and the response sentence between the user terminal and a specialist terminal to present advice information to the user in real time, and store implementation status information received from the user terminal in association with the advice information on energy management and generate control information for updating future prompt sentences and instructions to the generative AI model based on the implementation status information and subsequent energy usage information. This enables an improvement in computer technology by integrating anomaly detection, prompt sentence generation, conversational control, and adaptive feedback within a unified server-side processing architecture, thereby reducing processing redundancy, stabilizing response behavior of the generative AI model, and enhancing the efficiency and responsiveness of expert-assisted energy management interactions.

The term “processor” refers to a hardware computation unit or combination of units, such as a central processing unit or a microcontroller, configured to execute instructions stored in a memory to perform data processing, control, and communication functions of the system.

The term “storage device” refers to a hardware data retention component, such as a volatile memory or a non-volatile memory, configured to store energy usage information, historical information, dialogue history information, implementation status information, and control information for use by the processor.

The term “user terminal” refers to an information processing apparatus, such as a portable communication device or a fixed communication device, operated by a user and configured to transmit energy usage information and prompt sentences to the server and to receive notifications, advice information, and dialogue screens from the server.

The term “specialist terminal” refers to an information processing apparatus, such as a workstation or a portable communication device used by a specialist, configured to send and receive messages related to expert advice through the server and to participate in dialogue sessions managed by the system.

The term “energy usage information” refers to measurement data or derived data representing consumption of energy, including but not limited to electrical power, gas, or other utility resources, obtained from sensing devices or metering devices associated with a facility.

The term “historical information” refers to previously stored data related to energy usage, operational conditions, or system states, recorded over time in the storage device, and used as a basis for comparison, aggregation, or statistical analysis.

The term “time-series information” refers to data that is associated with chronological identifiers, such as timestamps or time intervals, enabling the processor to analyze changes or trends in the data over time.

The term “attribute information” refers to descriptive data associated with energy usage information, such as facility identifiers, equipment types, operational modes, or environmental conditions, which can be used for grouping, filtering, or classification.

The term “aggregation processing” refers to a computational operation performed by the processor that combines multiple data items into summary values, such as sums, averages, counts, or grouped metrics, over specified periods or categories.

The term “statistical processing” refers to a computational operation performed by the processor that applies statistical methods, such as variance calculation, standard deviation calculation, distribution analysis, or anomaly scoring, to energy usage information or related data.

The term “reference value” refers to a baseline metric, such as an average, typical, or expected energy usage level, computed or stored by the processor based on historical information or predefined criteria, and used for comparison with a current value.

The term “current value” refers to a metric representing energy usage at a recent or present time, calculated from energy usage information received from the user terminal or from sensing devices during a target period.

The term “abnormal state of energy usage” refers to a condition determined by the processor in which a current value deviates from a reference value by a threshold amount or according to an anomaly detection rule, indicating unusual or potentially problematic energy consumption.

The term “analysis result information” refers to structured data generated by the processor that summarizes outcomes of aggregation processing, statistical processing, anomaly detection, or other analysis performed on energy usage information.

The term “identification information” refers to data elements that uniquely or distinguishably specify an object within the system, such as a facility, a terminal, an equipment group, or an analysis record.

The term “time range information” refers to data indicating a period of time, such as a start time and an end time or a time window identifier, associated with analysis result information or an abnormal state of energy usage.

The term “energy usage increase ratio information” refers to data representing a proportional or percentage change in energy usage, calculated by comparing a current value to a reference value for a particular time range or condition.

The term “equipment type information” refers to data indicating a category or classification of equipment, such as heating, ventilation, air conditioning, lighting, or refrigeration, associated with corresponding energy usage information.

The term “prompt sentence” refers to a text string constructed by the processor, or input by a user, that is supplied to a generative AI model as part of an input request to control the content, style, or focus of a generated output.

The term “generative AI model” refers to a machine-learned computational model, such as a language model, configured to generate natural language text or other output in response to input data and prompt sentences.

The term “advice information on energy management” refers to natural language content or structured guidance generated by the generative AI model or by integration of model output and expert input, indicating recommended actions or strategies for controlling or improving energy usage.

The term “control prompt sentence” refers to a prompt sentence that includes meta-level instructions, such as domain information and conversation policy information, provided to the generative AI model to constrain or guide the behavior of the model in generating responses.

The term “domain information” refers to data indicating a technical or application field, such as energy management, facility operation, or utility optimization, which is used to limit or specialize the behavior of the generative AI model.

The term “conversation policy information” refers to data specifying rules or strategies for dialogue management, such as tone, level of detail, step-by-step guidance, or prioritization of topics, that the generative AI model should follow when generating responses.

The term “dialogue generation conditions” refers to parameters or constraints, derived from control prompt sentences or system settings, that determine how the generative AI model generates responses in a conversational context.

The term “conversation support information” refers to data structures and control information generated by the processor, including stored dialogue history and guidance parameters, that facilitate consistent, coherent, and efficient interactions between a user and a specialist.

The term “dialogue history information” refers to records of prior messages, including user messages, specialist messages, and AI-generated messages, stored in association with a dialogue session and used by the processor and the generative AI model to maintain conversational context.

The term “notification of the abnormal state of energy usage” refers to a message or alert generated by the processor and transmitted to a user terminal, indicating that an abnormal state of energy usage has been detected and optionally including summary analysis or guidance.

The term “control information for launching a dialogue screen” refers to data transmitted from the server to the user terminal that causes the user terminal to display or activate a user interface for a dialogue session with a specialist or an AI assistant.

The term “text information” refers to character-based data, including prompt sentences, user messages, specialist messages, and AI-generated messages, that is processed by the processor and the generative AI model for analysis or response generation.

The term “response sentence” refers to natural language text generated by the generative AI model or by the specialist and returned via the processor to the user terminal as a reply to a prompt sentence or query.

The term “implementation status information” refers to data indicating whether, and to what extent, recommended actions or advice related to energy management have been carried out by the user or by a facility, including completion flags, timestamps, or partial progress indicators.

The term “instructions to the generative AI model” refers to configuration data or control content, including prompt templates, system messages, or parameter settings, used by the processor to influence how the generative AI model processes inputs and generates outputs.

The term “trend analysis processing” refers to computational operations performed by the processor that identify patterns, tendencies, or long-term changes in energy usage information over multiple time intervals.

The term “anomaly detection processing” refers to computational operations performed by the processor to identify data points or time intervals in energy usage information that deviate significantly from expected patterns, reference values, or model predictions.

The term “control information” refers to data generated by the processor that specifies operations to be executed by system components, such as launching user interfaces, updating prompt templates, adjusting model parameters, or routing messages between terminals.

The server implements the invention by executing a program on one or more processors connected to a storage device, a communication interface, and external terminals.

The server may be realized on general-purpose computing hardware such as a rack-mounted server in a data center or a virtual machine instance in a cloud computing environment. The server runs an operating system such as a Unix-like operating system and application software components implemented, for example, in a high-level language. The storage device may include a main memory and a persistent storage device, such as a solid-state drive or a network-attached storage system.

The terminal implements a user-facing application on a portable device or a fixed device. The terminal includes a communication interface, a display, an input unit such as a touch panel or keyboard, and a processor executing an operating system such as a mobile operating system. The terminal runs an application that communicates with the server via a network, displays notifications and dialogue screens, and accepts user input including a prompt sentence.

The user operates the terminal in a facility equipped with energy measurement devices. The user may be, for example, a facility manager or an operator responsible for monitoring and controlling energy usage. The user views notifications on the terminal, submits prompt sentences, and confirms or records implementation status of recommended actions through the terminal application.

The server stores energy usage information in the storage device as a structured data record. The server receives, via the communication interface, measurement data from sensing devices installed in a facility or from an intermediate gateway device, and the server associates each measurement with a facility identifier, equipment identifier, timestamp, and attribute information such as device category and operational state. The server stores these data in a time-series data structure in the storage device, for example in a relational database or a columnar store optimized for analytical queries. By using a structured schema, the server enables efficient execution of aggregation processing and statistical processing over large volumes of energy usage information.

The server executes aggregation processing and statistical processing using numerical algorithms. The server groups energy usage records by time intervals, such as five-minute, fifteen-minute, or hourly bins, and by equipment categories or facility identifiers. The server computes aggregate measures such as total energy consumption, average consumption, peak value, and load factor for each group. The server further computes statistical indices including standard deviation, variance, and quantiles over historical data. The server uses these indices as reference values representing typical or expected energy usage patterns for a given facility and time-of-day segment.

The server determines an abnormal state of energy usage by comparing a current value with a reference value according to pre-defined or dynamically learned thresholds. The server computes a difference or ratio between the current aggregated consumption of a time interval and the reference value derived from historical information for the corresponding time-of-day and day-of-week. The server flags an abnormal state when the ratio or deviation exceeds a threshold, such as a twenty percent increase plus a multiple of the standard deviation. The server may implement a statistical anomaly detection algorithm, such as z-score based detection or a moving window comparison, to systematically classify each interval as normal or abnormal. By performing this processing on the server side using optimized data structures, the system reduces redundant data transfers and enables scalable detection across many facilities.

The server generates analysis result information as a machine-readable summary of detected abnormal states. The server creates an analysis record including identification information of the facility, identification information of the relevant equipment, time range information indicating the start and end times of the detected anomaly, and energy usage increase ratio information indicating the magnitude of deviation from the reference value. The server stores this analysis result in a separate table or index in the storage device for quick retrieval and for use in subsequent processing.

The server constructs a prompt sentence for a generative AI model by transforming the analysis result information into a natural language text string. The server uses a template-based generation method, in which the server inserts the facility identifier, time range, and increase ratio into predefined phrase patterns. For example, the server generates a prompt sentence such as:

“The energy consumption in the facility increased by 20% compared to the usual level during the period from 10:00 to 12:00. Please explain possible causes and propose concrete improvement measures.”

The server may also generate a system-level prompt sentence that defines the role and policy of the generative AI model, such as:

“You are an expert in energy management. Provide concise, technically accurate recommendations for reducing energy consumption without compromising safety or comfort.”

The server supplies both the analysis result information and the prompt sentence to the generative AI model via an application programming interface. In one embodiment, the generative AI model is implemented as a neural network language model with a transformer architecture, comprising multiple self-attention layers, feed-forward layers, and layer normalization modules. The model parameters are pre-trained on large-scale text data and optionally fine-tuned on domain-specific documents related to energy management. The model encodes the prompt sentence and contextual information into a sequence of input embeddings, propagates them through the network layers, and decodes a sequence of output tokens representing a natural language response.

The server configures the generative AI model with control prompt sentences that include domain information and conversation policy information. The control prompt sentence specifies, for example, that the model should focus on interpreting time-series anomalies, refer to equipment categories, prioritize low-cost and high-impact measures, and avoid making assumptions about unavailable data. By explicitly encoding such policies, the server reduces the risk of irrelevant or inconsistent responses and stabilizes the behavior of the generative AI model across different sessions. This controlled prompting is not merely a human-like instruction, but a machine-level protocol for shaping the internal token probability distribution of the model in a predictable manner.

The server generates advice information on energy management by obtaining the output text from the generative AI model. The server receives the sequence of output tokens, assembles them into a natural language string, and may perform post-processing operations such as truncation, segmentation into bullet points, or insertion of structured markers. The server then stores the generated advice information in association with the corresponding analysis result information, including the used prompt sentence and relevant model parameters such as version identifiers or decoding temperature values. By storing these associations, the server creates a traceable mapping between sensor data, anomaly detection, prompt generation, and AI output.

The server creates conversation support information by combining the advice information with dialogue history information. The server manages each dialogue session as a structured object containing a sequence of messages tagged with sender roles (user, specialist, AI), timestamps, and related analysis identifiers. The server stores these messages in a dialogue history table or document store in the storage device. By storing dialogue history in a structured form and linking it to analysis result information and prompt sentences, the server can efficiently rehydrate context for subsequent calls to the generative AI model and for display on both the user terminal and the specialist terminal.

The terminal displays notifications and dialogue screens based on control information from the server. When the server detects an abnormal state and generates advice information, the server transmits a notification message to the terminal. The terminal receives the message through a push notification mechanism or a persistent communication channel, and the terminal outputs a notification on the display indicating that an abnormal energy usage state has been detected. The terminal shows a brief summary, such as “Energy usage increased by 20% compared to usual,” and provides an interface element for launching a dialogue screen. Upon receiving control information specifying the dialogue session identifier, the terminal opens a dedicated screen displaying the AI-generated advice and a text input area for the user. The user reads the notification and opens the dialogue screen on the terminal. The user may input a prompt sentence directly, such as:

“The energy consumption in my store increased by 20% compared to the usual level. Please explain the possible causes and give me concrete improvement measures.”

The terminal transmits the user's input text to the server together with metadata such as session identifier and facility identifier. The terminal can also display a history of previous messages, including initial AI advice and, when available, specialist responses. This unified display allows the user to understand the progression of analysis and recommendations. The server receives text information from the terminal, including the prompt sentence, and updates the dialogue history information in the storage device. The server then constructs a new input sequence for the generative AI model that includes the latest user message, selected parts of the prior dialogue history, and relevant analysis result information. The server may apply a token budget management algorithm to select which parts of the dialogue history and analysis data to include, prioritizing the most recent and most relevant items. By doing so, the server ensures efficient use of the model's context window and reduces computational load while preserving necessary information.

The server relays messages between the user terminal and the specialist terminal when a human specialist participates in the dialogue. The server writes specialist messages into the same dialogue history structure used for AI messages, and the server may integrate specialist responses and AI-generated responses according to predetermined rules. For example, the server may prioritize specialist corrections or mark them as overriding AI suggestions in the conversation support information. The unified representation of messages enables both the user and the specialist to view a consistent conversation context, and it enables the server to use mixed human-AI histories as training or adaptation data for future improvements.

The user records implementation status information using the terminal. For example, after acting on recommended measures, the user may indicate on the terminal that “HVAC schedule has been updated” or “Lighting timer has been configured.” The terminal transmits these implementation status flags to the server along with timestamps and identifiers of the corresponding advice items. The server stores this implementation status information in association with the advice information and the relevant energy usage records.

The server uses the implementation status information and subsequent energy usage information to update future prompt sentences and instructions to the generative AI model. Specifically, the server can calculate, for each recommended action, a correlation between implementation events and subsequent changes in energy usage metrics. The server may compute performance measures such as average reduction in energy consumption, reduction in anomaly frequency, or improved stability of load profiles. Using these measures, the server can adjust thresholds used in anomaly detection, modify template phrasing of prompt sentences to emphasize more effective measures, or update control prompt sentences to instruct the generative AI model to prioritize recommendations that historically led to greater improvements.

The server can also implement learning algorithms that update internal parameters for prompt generation. For example, the server may maintain scores for different advice categories and store them in the storage device. Over time, the server increases the scores of advice categories that led to significant and consistent improvements and reduces the scores of less effective categories. The server uses these scores when constructing new prompt sentences by adding hints such as “focus on the following types of measures that have historically been effective: . . . ” By doing so, the server improves the technical performance of the overall system in terms of recommendation precision, convergence speed of anomaly mitigation, and computational efficiency of subsequent analyses.

The generative AI model may be trained or fine-tuned using a supervised learning procedure. During training, a training module supplies sequences of tokens representing prompt sentences and context data as inputs, and target sequences representing desired advice as outputs. The model parameters are updated by backpropagation using a loss function such as cross-entropy between predicted token distributions and target tokens. The training may incorporate domain-specific examples of energy anomalies, recommended actions, and dialogues between users and specialists. Data augmentation techniques can be applied, such as varying numeric values, time ranges, or facility characteristics, to improve generalization. The server may store model checkpoints and training metadata in the storage device for version control and for reproducibility.

The server may employ alternative model architectures and algorithms. In one embodiment, the generative AI model includes an encoder module that specifically processes structured analysis result information, such as tabular energy usage metrics and anomaly flags, converting them into vector representations. These vectors are then combined with embeddings of natural language prompt sentences in a joint representation space before being passed through transformer layers. In another embodiment, the server may combine a rule-based module with the generative AI model, where the rule-based module applies deterministic constraints such as safety limits or regulatory requirements, and filters or modifies the model's output accordingly. This hybrid approach yields improved robustness and compliance with operational constraints.

The server provides technical advantages beyond simple automation of human tasks. By integrating time-series anomaly detection, structured analysis result generation, controlled prompt sentence creation, and dialogue context management into a unified processing pipeline, the server reduces redundant computations and database accesses. For example, the server performs aggregation and anomaly detection once per time interval and reuses the resulting analysis result information for multiple dialogues, rather than re-querying raw sensor data for each user interaction. This reduces both processing load and communication overhead and leads to faster response times for the user.

The server also improves accuracy and consistency of recommendations by leveraging structured, machine-readable context in the prompt sentences. Instead of relying on ad hoc human descriptions of anomalies, the server systematically encodes numeric details and equipment classifications into the prompt, allowing the generative AI model to condition its internal probability distribution on precise data. This reduces ambiguities that often arise in natural language-only descriptions and therefore decreases the likelihood of erroneous or irrelevant recommendations.

The terminal contributes to technical effects by offloading certain processing tasks from the server and by managing user interaction efficiently. The terminal can pre-filter or compress data before sending it to the server, can cache recent notifications and dialogue histories for quick display, and can apply user interface logic that reduces repeated network calls, for example by locally rendering static parts of advice and requesting only incremental updates. These measures lower communication latency and network bandwidth consumption.

The user benefits from improved responsiveness and clarity of information. When the user enters a prompt sentence, the system does not simply forward the text to a human specialist. Instead, the server processes the prompt sentence together with structured analysis results and uses the generative AI model under controlled conditions, producing a technically grounded, context-aware answer. The user receives integrated advice that combines AI-generated guidance and specialist input, and the user can observe, through subsequent sensor measurements, the quantitative effects of implementing such advice.

The invention can be varied in multiple embodiments. In one embodiment, the server may reside in a cloud computing environment and support a large number of facilities simultaneously, scaling anomaly detection and prompt generation using distributed processing frameworks. In another embodiment, the server may be deployed locally in a building management system, interfacing directly with local controllers to adjust equipment schedules based on recommended actions, where the adjustments are still based on the described analysis results and generative AI outputs. In yet another embodiment, the terminal may be a web browser running on a general-purpose computer, and the specialist terminal may be an application integrated with a customer support platform.

In all embodiments, the server, the terminal, and the user cooperate through the described data structures and processing flows so that the generative AI model is not used as an opaque black box, but as a controlled computational component integrated into a technically specific architecture. This architecture improves processing efficiency, response accuracy, data management, and communication usage, and therefore represents an improvement in computer technology itself rather than a mere computerization of a manual consultation process.

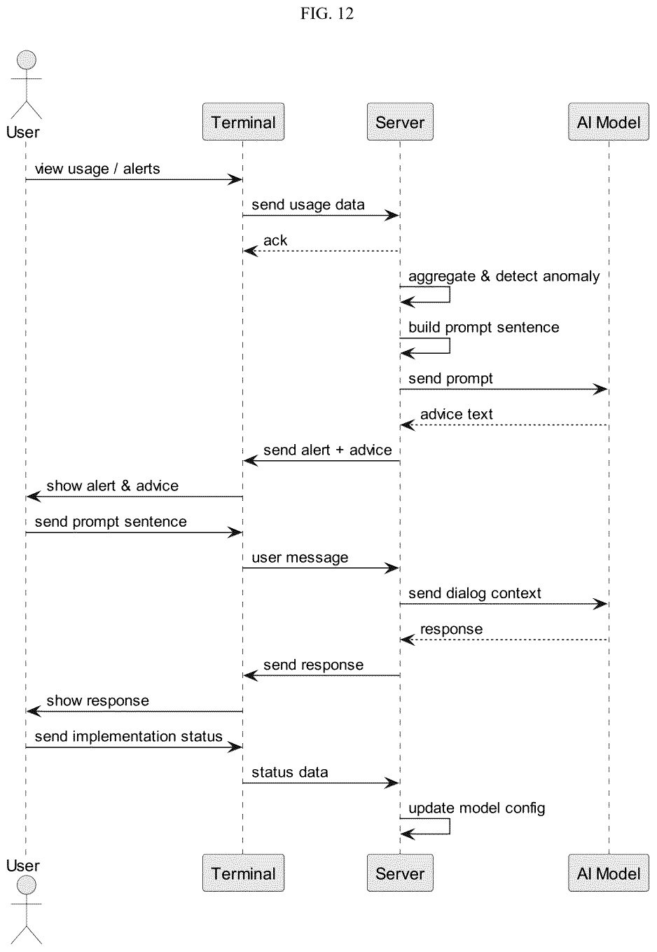

The following describes the processing flow using FIG. 12.

### Step 1:

The terminal acquires energy usage information from sensing devices or from a local gateway and prepares it for transmission to the server. The input to this step is raw measurement data including timestamps, device identifiers, and instantaneous consumption values. The terminal converts the raw data into a normalized record structure, for example adding facility identifiers, equipment type attributes, and sampling interval information. The terminal performs basic validation, such as checking for missing timestamps and discarding clearly invalid values, and then outputs a structured data message formatted for network transmission.

### Step 2:

The terminal transmits the structured energy usage information to the server via a communication network. The input to this step is the normalized data message produced in Step 1. The terminal encapsulates the data in a network request, attaches authentication tokens and compression headers if necessary, and sends the request to a designated endpoint of the server. The terminal outputs a network packet or a series of packets containing the energy usage information for reception by the server.

### Step 3:

The server receives energy usage information from the terminal and stores it in a storage device as time-series records. The input to this step is the network packet or request body containing structured energy usage data. The server decodes the message, verifies authentication, parses the content into internal data structures, and performs schema validation to ensure that all required fields such as facility identifier, timestamp, and consumption value are present and within allowable ranges. The server then writes the validated records into a time-series data store or a database table, assigning index keys for fast retrieval. The output is a set of persistent time-series records associated with corresponding facilities and equipment.

### Step 4:

The server aggregates the stored energy usage information over defined time intervals and attribute categories. The input to this step is the set of time-series records stored in the database for a target analysis period. The server groups records by facility, equipment type, and time window (for example, fifteen minutes or one hour), and computes aggregate measures such as sum, average, minimum, maximum, and peak occurrence time. The server applies arithmetic operations to sum consumption values, divide by the number of samples for averages, and evaluate comparisons for min/max. The output is a collection of aggregated energy usage metrics for each facility and equipment category over specific time intervals.

### Step 5:

The server computes reference values and performs statistical processing on historical energy usage information. The input to this step is the aggregated metrics from Step 4 and historical aggregated metrics for corresponding facilities, equipment categories, and time-of-day segments. The server calculates baseline reference values such as historical means, medians, and standard deviations by applying statistical formulas to past data. The server may compute moving averages over multiple days or weeks and store these as baseline profiles. The output is a set of reference values and statistical parameters for each analysis dimension, such as “typical consumption for facility A, equipment type B, at 10:00-11:00 on weekdays.”

### Step 6:

The server detects an abnormal state of energy usage by comparing current aggregated values with reference values. The input to this step is the current aggregated metrics from Step 4 and the statistical parameters from Step 5. The server calculates deviations by subtracting the reference value from the current value and computes increase ratios by dividing the deviation by the reference value. The server then applies anomaly detection criteria, for example marking a time window as abnormal if the increase ratio exceeds a threshold (such as 20%) and the absolute deviation exceeds a multiple of the standard deviation. The server outputs anomaly flags and associated scores indicating whether each time interval is normal or abnormal for each facility and equipment category.

### Step 7:

The server generates analysis result information for each detected abnormal state. The input to this step is the set of anomaly flags and the underlying aggregated metrics. The server selects records flagged as abnormal and extracts facility identification information, equipment type information, and the corresponding time range. The server calculates an explicit energy usage increase ratio and may compute additional descriptive features such as duration of the anomaly and cumulative excess consumption. The server assembles these elements into structured analysis result records and stores them in a dedicated analysis table or index. The output is a set of analysis result information items representing summarized anomaly descriptions.

### Step 8:

The server constructs a prompt sentence for a generative AI model based on the analysis result information. The input to this step is an analysis result record containing facility identifiers, time ranges, increase ratios, and equipment categories. The server selects an appropriate template and inserts numeric and categorical values into placeholder positions using string formatting operations. For example, the server generates a prompt sentence such as, “The energy consumption in the facility increased by 20% compared to the usual level between 10:00 and 12:00 for the air conditioning equipment. Please explain possible causes and propose concrete improvement measures.” The server outputs a completed prompt sentence associated with the corresponding analysis result record.

### Step 9:

The server generates a control prompt sentence that encodes domain information and conversation policy for the generative AI model. The input to this step is configuration data describing the energy management domain, desired response style, and safety constraints. The server composes a control prompt sentence specifying, for example, that the model should act as an energy management expert, prioritize safe and cost-effective actions, and provide step-by-step guidance. The server may also embed rules such as “do not suggest actions that require changing protective devices without expert supervision.” The output is a control prompt sentence that can be combined with the user-facing prompt sentence in subsequent model calls.

### Step 10:

The server prepares input data for the generative AI model by combining the prompt sentence, the control prompt sentence, and structured analysis result information. The input to this step is the natural language prompt sentence, the control prompt sentence, and the structured features such as numeric increase ratios and equipment identifiers. The server encodes the combined textual input into token sequences and, in some embodiments, encodes structured features into embeddings or key-value pairs. The server arranges the data into a model-specific request format and outputs a model input object suitable for submission to the generative AI model.

### Step 11:

The server invokes the generative AI model to generate advice information on energy management. The input to this step is the model input object prepared in Step 10. The server transmits the encoded prompt and context to the model inference engine, which internally applies a sequence of neural network operations such as self-attention, matrix multiplications, and non-linear activations. The server receives, as output, a sequence of tokens representing a natural language response. The server decodes the tokens into a text string and may segment the text into sections such as “Possible causes” and “Recommended measures” by detecting headings or by inserting markers during post-processing. The output is advice information on energy management expressed in natural language.

### Step 12:

The server stores the generated advice information and associates it with the corresponding analysis result and model configuration. The input to this step is the advice text from Step 11 and the analysis result record from Step 7, along with metadata such as model version, decoding parameters, and timestamps. The server writes these data into an advice history table in the storage device, creating a linkage between sensor data anomalies, prompt sentences, and AI output. The server also tags each advice entry with identifiers that can be used to retrieve it in dialogue sessions. The output is a persistent advice history that supports traceability and later reuse.

### Step 13:

The server generates conversation support information including dialogue history and guidance parameters. The input to this step is the stored advice information, existing dialogue history for the relevant facility or user, and conversation policy settings. The server creates or updates a dialogue session object that contains an ordered list of messages, starting with system notices about the anomaly, followed by the AI-generated advice. The server attaches conversation policy parameters such as maximum response length and recommended next actions. The server outputs a conversation support structure that can be transmitted to terminals and reused in subsequent model calls.

### Step 14:

The server sends a notification of the abnormal state and the availability of advice information to the terminal. The input to this step is the conversation support information from Step 13 and targeting information for the user. The server extracts a concise summary of the anomaly and key points of the advice, and packages these into a notification payload that includes a dialogue session identifier and control information for launching a dialogue screen. The server then transmits this payload through a push notification channel or an API response. The output is a notification message delivered to the terminal that can trigger user interaction.

### Step 15:

The terminal receives the notification and displays it to the user. The input to this step is the notification payload from the server. The terminal decodes the payload, extracts the summary text and session identifier, and renders a notification on the display including a short message, such as “Energy usage increased by 20% compared to usual. Tap to view details and recommendations.” The terminal also stores the session identifier in local memory for use when the user opens the dialogue screen. The output is a visible notification and an internal association between the notification and a dialogue session.

### Step 16:

The user operates the terminal to open a dialogue screen related to the detected abnormal state. The input to this step is the notification displayed on the terminal and the user's action, such as tapping the notification. The user triggers the terminal application to request the full conversation support information from the server. The user's interaction causes the terminal to create a request containing the session identifier and send it to the server. The output is a server-directed request signaling that the user wishes to start or continue a dialogue about the specific anomaly.

### Step 17:

The server provides the terminal with the full dialogue history and initial advice content. The input to this step is the request containing the session identifier. The server retrieves the corresponding dialogue session object, including existing messages and advice information from the storage device. The server may filter or order messages for initial display, such as showing the most recent AI-generated advice first. The server then formats the data as a dialogue history response and transmits it to the terminal. The output is a structured set of messages and guidance parameters suitable for rendering a dialogue screen.

### Step 18:

The terminal renders the dialogue screen using the received dialogue history and advice information. The input to this step is the dialogue history response from the server. The terminal constructs a conversation-style display, placing messages in chronological or logical order and clearly distinguishing AI-generated messages from system notices. The terminal also displays a text input field for the user to enter a prompt sentence, and may show buttons for quick actions, such as “Mark advice as implemented.” The output is an interactive dialogue interface visible to the user.

### Step 19:

The user inputs a prompt sentence into the dialogue screen to request further explanations or additional recommendations. The input to this step is the displayed dialogue interface. The user may type, for example, “Please give me a step-by-step schedule for adjusting lighting and HVAC settings for opening hours 10:00-20:00.” The user confirms the message by tapping a send button. The output is a newly created user message containing the prompt sentence and associated with the current dialogue session.

### Step 20:

The terminal sends the user's prompt sentence and related metadata to the server. The input to this step is the user's message from Step 19 and session context stored locally. The terminal creates a message object including the text content, user identifier, facility identifier, and session identifier, and transmits it via a network request or a persistent communication channel. The terminal may also display a temporary “sending” state while awaiting a server response. The output is a message packet delivered to the server.

### Step 21:

The server updates the dialogue history with the user's prompt sentence and prepares context for a new call to the generative AI model. The input to this step is the message packet from the terminal and the existing dialogue session object. The server appends the user message to the dialogue history, assigning it a timestamp and role label. The server then selects a subset of messages and relevant analysis result information to include as context for the model, using a selection algorithm that respects a maximum token budget and prioritizes recent and high-relevance messages. The output is an updated dialogue history and a curated context bundle for model input.

### Step 22:

The server constructs a new combined prompt for the generative AI model incorporating the user's latest prompt sentence, the existing advice, and conversation policy. The input to this step is the curated context bundle and the control prompt sentence from Step 9. The server concatenates the control prompt sentence with an encoded representation of the dialogue history, followed by the user's newest prompt. The server may annotate roles (system, user, assistant) to reflect conversational turns. The output is a structured, conversation-aware prompt that conditions the generative AI model on both past messages and current user intent.

### Step 23:

The server invokes the generative AI model with the conversation-aware prompt and obtains a response sentence. The input to this step is the structured prompt from Step 22. The server sends this prompt to the model inference engine and receives an output token sequence that represents the model's reply. The server decodes the sequence into text and may enforce formatting constraints, such as ensuring that the response includes numbered steps when the user requests a schedule. The output is a response sentence that logically follows the dialogue and addresses the user's current request.

### Step 24:

The server evaluates and stores the AI-generated response and prepares it for delivery to the terminal and, optionally, to the specialist terminal. The input to this step is the response sentence from Step 23 and the updated dialogue session object. The server may perform basic checks for prohibited content or inconsistent references and may merge the response with additional disclaimers or links to internal documentation. The server then appends the response as an AI-generated message in the dialogue history and stores it in the storage device. The output is an updated dialogue history containing the new AI response and a prepared response payload for terminals.

### Step 25:

The server delivers the response sentence to the terminal in real time. The input to this step is the prepared response payload from Step 24 and the current connection status with the terminal. The server sends the response through the established communication channel, including the session identifier and message sequence number. The server may also send the same response to the specialist terminal so that the specialist can see what the AI has suggested. The output is a network message reaching the terminal with the new AI-generated response.

### Step 26:

The terminal updates the dialogue screen to display the new AI-generated response to the user. The input to this step is the response message from the server. The terminal adds the AI message to the conversation view, placing it in proper chronological order and marking it with a distinct label to indicate that it is generated by the AI assistant. The terminal may scroll the view to make the new message visible and may clear the input field to indicate that the prior user request has been answered. The output is an updated on-screen dialogue that incorporates the AI's latest response.

### Step 27:

The user reviews the advice and records implementation status when actions are carried out. The input to this step is the displayed AI recommendations and any specialist comments. The user may select checkboxes or buttons on the terminal interface to mark specific recommendations as implemented, partially implemented, or not applicable. The user may also add comments, such as “Adjusted HVAC schedule as suggested.” The output is structured implementation status information captured on the terminal.

### Step 28:

The terminal sends implementation status information to the server for storage and further analysis. The input to this step is the implementation status data selected or entered by the user, along with identifiers of the relevant advice items and timestamps. The terminal packages this information into a request object and transmits it to the server. The output is a message received by the server that describes how the user has acted on one or more recommendations.

### Step 29:

The server stores the implementation status information and links it to the original advice and energy usage data. The input to this step is the implementation status message and the associated advice history and analysis result information. The server creates or updates records in an implementation status table, associating each implementation event with specific advice entries, time ranges, and facilities. The server may also compute initial indicators, such as whether subsequent energy usage metrics fall within normal ranges after implementation. The output is a structured record of implementation actions correlated with recommendations and sensor data.

### Step 30:

The server periodically analyzes the correlation between implementation status information and subsequent energy usage to update future prompt sentences and model instructions. The input to this step is the implementation status table, advice history, and post-implementation energy usage metrics. The server applies analytical algorithms to measure changes in consumption patterns after implemented actions, calculates effectiveness scores for different types of recommendations, and identifies which advice categories most consistently lead to anomaly reduction. Based on these results, the server adjusts parameters for anomaly thresholds, modifies template content for prompt sentences to emphasize successful strategies, and updates control prompt sentences to instruct the generative AI model to prioritize or de-prioritize specific recommendation types. The output is an updated set of configuration parameters and refined prompt generation rules that improve the technical performance and effectiveness of subsequent system operations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval systems that answer user questions about a specific industry typically rely on simple keyword matching or static rule-based processing. Such systems often retrieve large volumes of loosely related documents and leave to the user or to a separate application the burden of synthesizing those documents into a coherent answer. In addition, existing systems generally do not tightly integrate (i) continuous ingestion and natural language processing of external textual sources, (ii) structured storage with relevance-aware indexing, and (iii) controlled use of a generative AI model that is constrained by retrieved, domain-specific context. As a result, these systems generate responses that can be incomplete, outdated, or hallucinated, and they require substantial engineering effort to keep search performance, answer quality, and latency within acceptable ranges.

From a computer-technology perspective, there is a need to improve how computing resources are used to transform incoming unstructured text from multiple external sources into an indexed, semantically annotated corpus, and then to use that corpus efficiently as a context for a generative AI model in response to user prompt sentences. Existing architectures do not provide an integrated control flow at the processor level that: (a) automatically acquires and normalizes heterogeneous document data from distributed information providing apparatuses, (b) performs multi-step natural language processing to generate topic classification information and relevance evaluation information, (c) constructs and maintains full-text and attribute indexes optimized for subsequent generative processing, and (d) dynamically composes a model input context from the indexed corpus under token-length constraints while prioritizing highly relevant content. In the absence of such integrated control, the processor may perform redundant searches, transfer excessive or irrelevant context to the generative AI model, and incur unnecessary computation and network overhead, resulting in degraded throughput and response quality.

Furthermore, conventional generative AI integrations often treat the model as an isolated component that receives raw user queries and optionally a flat list of documents. There is little or no systematic mechanism by which the processor interprets the prompt sentence, derives structured search conditions, and programmatically constrains the model to operate over a curated, relevance-ranked subset of documents. This lack of orchestration leads to inefficient usage of model tokens, increased inference time, and unstable answer quality. There is therefore a need for an improved computer-implemented technique that configures the processor to control the entire pipeline—from prompt analysis through document retrieval and context construction to answer generation—in a way that enhances accuracy, efficiency, and determinism of responses generated by a generative AI model.

Accordingly, it is an object of the invention to provide a system that technically improves the functioning of a computer by configuring a processor to: (1) automatically acquire and pre-process industry-related document data from external information sources using natural language processing; (2) store the resulting natural language text in an information storage apparatus with topic classification information, relevance evaluation information, and optimized indexes; and (3) interpret user prompt sentences to construct a prioritized, length-constrained context for a generative AI model so that the model generates answer texts that are more relevant, up-to-date, and computationally efficient to obtain.

The specific processing by the specific processing unit 290 of the data processing device 12 in Example 2 is realized by the following means.

The present invention provides a server comprising a processor configured to receive a prompt sentence from a user terminal and analyze the prompt sentence by using a generative AI model or natural language processing so as to extract an information request content, a target field, and a time condition; obtain standardized document data from an information providing apparatus that provides industry-related information via a communication network based on pre-stored information source identification information; remove structural information from the obtained document data to extract natural language text; execute natural language processing including morphological analysis, phrase segmentation, and important phrase extraction on the natural language text; generate topic classification information and relevance evaluation information regarding the natural language text; store the natural language text together with attribute information based on the topic classification information and the relevance evaluation information in an information storage apparatus; construct, in the information storage apparatus, a full-text search index and an attribute index for the natural language text; search the information storage apparatus based on search conditions corresponding to an analysis result of the prompt sentence; acquire a plurality of pieces of document data and summary information corresponding thereto that satisfy the search conditions; construct the plurality of pieces of document data and the summary information as context for input to the generative AI model, including calculating a priority based on the relevance evaluation information and selecting or dividing the document data and the summary information so as to satisfy a predetermined length constraint; and input the context and the prompt sentence to the generative AI model, cause the generative AI model to generate an answer text based on the context and the prompt sentence, and transmit the generated answer text to the user terminal. This enables a technical improvement in computer functionality by orchestrating data ingestion, semantic indexing, and constrained generative inference within the processor so that relevant domain-specific information is automatically collected, organized, and selectively supplied to the generative AI model, thereby reducing unnecessary computation and network usage, improving retrieval accuracy, stabilizing response latency, and enhancing the reliability and relevance of generated answer texts.

The term “system” refers to an integrated combination of hardware and software components, including at least one processor and one or more storage devices, that cooperate to perform the claimed processing operations.

The term “processor” refers to one or more hardware processing units, such as a central processing unit or a processing core, configured by executable instructions to perform arithmetic, logical, control, and input/output operations.

The term “user terminal” refers to an information processing device operated by a user, such as a computing device that transmits a prompt sentence to the system and receives an answer text from the system via a communication network.

The term “prompt sentence” refers to a natural language text string input by a user to request information, ask a question, or specify a task to be processed by the system or by a generative AI model.

The term “generative AI model” refers to a machine-learned model configured to generate natural language output text based on input data, including at least a prompt sentence and optionally additional context.

The term “information request content” refers to a semantic representation of what information the user is requesting in the prompt sentence, including a subject matter and a requested type of output.

The term “target field” refers to a category or domain of information indicated by the prompt sentence, such as a specific industry sector or technical area for which information is to be retrieved.

The term “time condition” refers to a temporal constraint derived from the prompt sentence, such as a period, date range, or recency requirement that limits which document data is considered relevant.

The term “information providing apparatus” refers to an external information processing system or service that provides industry-related document data via a communication network.

The term “communication network” refers to a data transmission infrastructure, such as a wired or wireless network, that enables data exchange between the server and external apparatuses or user terminals.

The term “information source identification information” refers to configuration data that specifies one or more external information sources, such as source identifiers or addresses, from which document data is to be obtained.

The term “standardized document data” refers to document data that has been converted from heterogeneous source formats into a normalized internal format suitable for subsequent processing by the system.

The term “structural information” refers to non-content elements of document data, such as markup tags, layout information, navigation elements, and formatting metadata, that are removed in order to obtain natural language text.

The term “natural language text” refers to content data expressed in a human language, such as sentences and paragraphs, obtained from document data after removal of structural information.

The term “natural language processing” refers to a set of computational techniques for analyzing natural language text, including at least morphological analysis, phrase segmentation, and important phrase extraction.

The term “morphological analysis” refers to processing in which natural language text is segmented into morphemes or tokens and grammatical attributes such as part-of-speech are assigned.

The term “phrase segmentation” refers to processing in which a sequence of tokens in natural language text is divided into phrases, clauses, or other multi-word units based on syntactic or statistical criteria.

The term “important phrase extraction” refers to processing in which phrases that are determined to be significant to the meaning or topic of the text are identified and selected based on statistical or rule-based methods.

The term “topic classification information” refers to classification data indicating one or more topics or categories to which a piece of natural language text belongs, such as policy, pricing, or equipment efficiency.

The term “relevance evaluation information” refers to evaluation data indicating how strongly a piece of natural language text is related to one or more topics or to a potential information request, typically represented as scores or weights.

The term “attribute information” refers to metadata associated with natural language text, including at least topic classification information, relevance evaluation information, and additional properties such as source, date, or category.

The term “information storage apparatus” refers to a storage subsystem, such as a database system or a storage device, configured to store, organize, and retrieve natural language text and associated information.

The term “full-text search index” refers to an index structure constructed over the content of natural language text that enables efficient searching of documents based on the occurrence of words, phrases, or tokens.

The term “attribute index” refers to an index structure constructed over attribute information, such as topic labels or dates, that enables efficient retrieval of documents satisfying attribute-based conditions.

The term “search conditions” refers to a set of constraints or parameters derived from the analysis result of the prompt sentence, including at least a target field, a time condition, and one or more keywords or topics used to query the information storage apparatus.

The term “document data” refers to structured or semi-structured data representing an individual document, including at least natural language text and associated metadata.

The term “summary information” refers to condensed natural language text that expresses main points of corresponding document data in a shorter form than the original text.

The term “context for input” refers to a collection of document data, summary information, or other auxiliary information that is provided together with the prompt sentence as input to the generative AI model.

The term “priority” refers to a relative ranking value assigned to document data based on relevance evaluation information or other criteria, used to determine an order or selection of documents for inclusion in the context.

The term “predetermined length constraint” refers to a limit on the size of the context, such as a maximum number of tokens, characters, or documents, that is determined in advance in view of capabilities of the generative AI model or system requirements.

The term “answer text” refers to natural language text generated by the generative AI model in response to a prompt sentence and context, to be provided as an answer to the user.

The server implements the invention by executing a computer program on one or more hardware processors and storage devices that are configured according to the claims. The server typically includes a multicore central processing unit, a main memory, a nonvolatile storage device such as a solid-state drive, and a network interface. The server optionally includes one or more graphics processing units for accelerating neural network inference. The server executes a general-purpose operating system and middleware such as a web server framework and a database management system.

The server uses a combination of software modules to realize the claimed functions. The server uses a network communication module to obtain document data from external information providing apparatuses via a communication network. The server uses a data normalization module to convert heterogeneous document formats into standardized document data. The server uses a natural language processing module to extract and annotate natural language text. The server uses a storage module to persist the annotated text together with attribute information in an information storage apparatus. The server uses an index construction module to create a full-text search index and an attribute index. The server uses a query interpretation module to analyze a prompt sentence received from a user terminal. The server uses a context construction module to select relevant document data and summary information and to construct context for input to a generative AI model. The server uses an inference module to perform neural network inference using the generative AI model to generate an answer text. The server uses a response transmission module to send the answer text back to the user terminal.

The server uses specific software examples to implement these modules. The server can execute a web application framework such as a general-purpose server-side framework written in a high-level programming language to provide an application programming interface that receives prompt sentences and returns answer texts. The server can execute a database management system such as a relational database engine to store natural language text and associated attribute information. The server can execute a natural language processing library such as an open-source language processing toolkit to perform tokenization, part-of-speech tagging, and named entity recognition. The server can execute a machine learning framework such as a tensor-based numerical computation library to run the generative AI model, which can be a transformer-based neural network like a sequence-to-sequence model or an auto-regressive language model with multi-head self-attention layers. The server defines specific data structures to support the technical effects of the invention. The server stores, for each document, a record that includes: a document identifier, a source identifier, a retrieval timestamp, a publication date, a normalized title text, a normalized body text, topic classification information, relevance evaluation information, and additional attribute values such as an industry category or a regulatory category. The server stores the normalized title text and body text as sequences of tokens. The server stores topic classification information as a vector of topic scores where each element corresponds to a predefined topic label and holds a real-valued probability or confidence score. The server stores relevance evaluation information as at least one scalar value that indicates the relative importance of the document with respect to a set of reference topics or use cases. The server constructs a full-text index by mapping tokens to postings lists that reference document identifiers and token positions. The server constructs an attribute index by mapping attribute values such as topic labels or time ranges to sets of document identifiers.

The server uses specific algorithms and neural network structures to improve computer functionality beyond human mental steps. The server uses a transformer-based generative AI model that includes an embedding layer that maps tokens into high-dimensional vectors, a plurality of transformer blocks, and an output projection layer. Each transformer block includes multi-head self-attention sublayers and feed-forward sublayers. The server configures the generative AI model with hyperparameters including the number of layers, the hidden dimension size, the number of attention heads, and activation functions. The server trains or fine-tunes the generative AI model using supervised learning on domain-specific corpora. The server uses a loss function such as cross-entropy between predicted token distributions and ground-truth token sequences. The server updates model weights using an optimization algorithm such as stochastic gradient descent with adaptive learning rates. The server optionally uses data augmentation methods such as paraphrasing and sentence reordering to increase robustness. These model training and adaptation steps produce a generative AI model that is structurally and parametrically configured to operate efficiently on domain-specific information.

The server does not simply allow the generative AI model to process arbitrary user text. Instead, the server controls the inputs to the model using non-conventional rules and data flows. When the server receives a prompt sentence from a user terminal, the server first performs natural language processing outside the generative AI model to interpret the prompt sentence. The server tokenizes the prompt sentence, identifies key phrases, and classifies the prompt sentence into one or more predefined intent categories. The server then maps the interpreted intent to structured search conditions including a target field, a time condition, and keyword constraints that are applied to the full-text search index and attribute index. This rule-based and model-assisted mapping ensures that the server queries the information storage apparatus in a structured manner rather than relying on the generative AI model to search raw text.

The server uses these search conditions to retrieve a plurality of candidate documents from the information storage apparatus. The server uses the attribute index to filter documents by topic classification information and publication date according to the target field and time condition extracted from the prompt sentence. The server uses the full-text index to filter and rank documents based on the presence of relevant tokens and phrases identified in the prompt sentence. The server then computes a priority score for each candidate document by combining relevance evaluation information stored in the database with similarity scores computed between document embeddings and an embedding of the prompt sentence. For example, the server uses a separate embedding model to map both the prompt sentence and document summaries into a vector space and calculates cosine similarity, then combines this with the stored relevance evaluation information using a weighted sum. This composite score gives a nontrivial ranking that is not simply keyword matching.

The server constructs the context for input to the generative AI model by selecting documents in descending order of the composite score until a predetermined length constraint is reached. The server calculates the approximate token length of each document summary and main content using a tokenizer compatible with the generative AI model. The server maintains a running total of tokens and selects documents until including another document would exceed the maximum token budget. The server optionally truncates low-priority parts of a document summary while preserving high-priority segments, thus implementing non-standard selection and segmentation rules tied directly to model capacity. This selective inclusion of context reduces the amount of data transferred to the generative AI model and minimizes computation required for generating answer texts.

The server integrates the technical modules to produce tangible improvements in computer operation. By storing topic classification information and relevance evaluation information in the information storage apparatus, the server reduces the need to re-run heavy classification models at query time and instead reuses precomputed attributes. This results in lower latency and reduced processor load during query handling. By building and maintaining full-text and attribute indexes, the server reduces the complexity of retrieval from linear scans to logarithmic or near-logarithmic searches, improving response time when the number of stored documents becomes large. By computing composite scores and enforcing token-length constraints before calling the generative AI model, the server reduces the size of the model input and thus the number of operations in each attention layer, which leads to measurable reductions in inference time and power consumption on the hardware accelerator.

The server leverages the generative AI model in a controlled way that yields more accurate and stable answers. Because the server supplies context that has already been filtered and ranked according to topic classification information and relevance evaluation information, the generative AI model is discouraged, by construction, from relying on unrelated training data that could cause hallucinations. The server uses system-level instructions within the input to the generative AI model to constrain the model to facts contained in the provided context. This coordinated input design, along with the pre-filtered context, results in higher answer precision and fewer spurious outputs compared to a system that directly passes the prompt sentence to a generative AI model without such orchestration.

The server makes use of specific prompt sentences as examples of how the system operates in practice. The user enters, via the user terminal, prompt sentences such as “Please summarize the latest regulations for high-efficiency gas equipment.”, “Show me trends in energy-efficient devices for residential use.”, or “What are the recent policy changes that affect electricity tariffs?”. The server interprets these prompt sentences, converts them into search conditions, retrieves and ranks relevant documents, constructs context, and then causes the generative AI model to produce an answer text such as a concise description of new efficiency standards, recent incentive programs, or regulatory changes. These concrete sequences illustrate that the server is not merely automating a human's reading and summarization activity; instead, the server implements machine-specific workflows involving indexing structures, vector scoring, and model input shaping that are not feasible in a purely manual environment.

The terminal provides an interface through which the user interacts with the system. The terminal typically includes a display, an input device, a local processor, and a communication module. The terminal executes a client application or web browser that displays a text input area where the user can type the prompt sentence. The terminal transmits the prompt sentence and receives the answer text via secure network protocols. The terminal can display the answer text along with optional metadata such as document titles and publication dates. The terminal may allow the user to issue follow-up prompt sentences that refine or extend the request; in such cases, the server can include excerpts from previous context as part of the new context for the generative AI model, thereby enabling multi-turn interaction without duplicating all prior computational steps.

The user operates the terminal to request and consume information produced by the server. The user can change the type of prompt sentence to emphasize different target fields or time conditions. For example, the user can input “Explain energy-efficient residential gas appliances introduced in the last six months.” to emphasize a shorter time window, or “Compare recent regulations for electricity and gas tariffs.” to request a comparative summary. The user can thereby exercise control over the server's data retrieval, indexing utilization, and context construction indirectly through natural language instructions. The user does not need to know the details of index structures, embeddings, or neural network architectures; those are handled internally by the server to improve the technical performance of the overall system.

The server can be implemented in alternative embodiments and configurations. In one embodiment, the server uses a relational database as the information storage apparatus and uses an inverted index implemented by the database engine. In another embodiment, the server stores document data in a distributed document-oriented database and maintains external full-text and attribute indexes in a dedicated search engine. In one embodiment, the server runs the generative AI model on a local hardware accelerator, while in another embodiment the server calls a remote inference service that executes the model. In some embodiments, the server uses a single large generative AI model for both prompt interpretation and answer generation. In other embodiments, the server uses a lighter-weight classifier model for prompt interpretation and reserves the generative AI model solely for answer generation. These variations still fall within the scope of the claimed invention because they preserve the structural features of pre-processing external document data, storing annotated text in an indexed information storage apparatus, interpreting prompt sentences into structured search conditions, and constructing length-constrained, priority-based context for a generative AI model.

The server in all embodiments is configured to achieve technical improvements in processing speed, retrieval precision, and resource efficiency. The combination of precomputed semantic attributes, optimized indexes, relevance-based ranking, and token-budget-aware context construction directly reduces the number of operations required to respond to a given prompt sentence, which in turn reduces latency and hardware utilization. The structured integration of a generative AI model with these components yields improved answer quality and consistency. These effects arise from the particular manner in which the server configures and uses computer resources and are therefore technical in nature, not merely automation of human mental tasks or business logic.

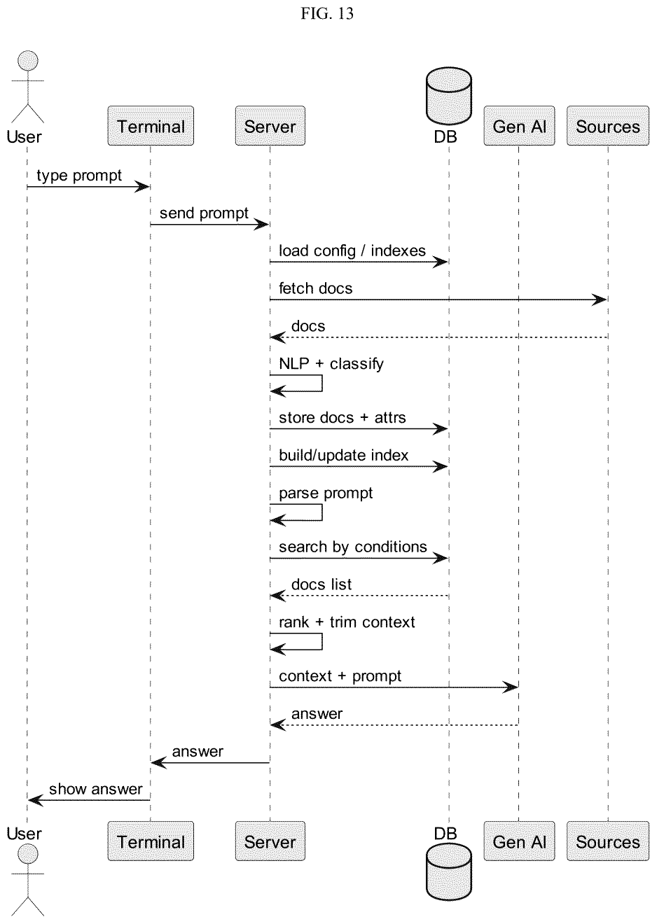

The following describes the processing flow using FIG. 13.

### Step 1:

The server loads configuration data that specifies information source identification information and processing parameters.

The input is configuration data stored in a configuration file or configuration database, including a list of source addresses, crawling intervals, parsing rules, topic labels, and index parameters.

The server parses the configuration data, converts each entry into an internal data structure (for example, a list of source descriptors), and initializes internal modules such as a network communication module, a natural language processing module, a storage module, and an index construction module.

The output is an initialized runtime state including in-memory structures that define which external information providing apparatuses to access and how to normalize and classify incoming document data.

### Step 2:

The server periodically obtains standardized document data from external information providing apparatuses via a communication network.

The input is the list of source descriptors loaded in Step 1, each containing a network address and retrieval method.

The server sends network requests to each external apparatus, receives raw responses such as HTML pages or structured feeds, and converts heterogeneous formats into a standardized internal document representation that includes a source identifier, retrieval timestamp, and raw content field.

The output is a collection of standardized document data objects held in memory or temporary storage for further processing.

### Step 3:

The server extracts natural language text from the standardized document data by removing structural information.

The input is each standardized document data object containing raw content that may include markup tags, layout elements, or control codes.

The server applies a parser to separate content text from structural information, discards elements such as navigation menus and style tags, normalizes whitespace, and encodes the remaining content as natural language text for a title field and a body field.

The output is a set of text records in which each record contains a document identifier, a title text string, and a body text string suitable for natural language processing.

### Step 4:

The server performs natural language processing on the extracted natural language text to obtain linguistic tokens and candidate phrases.

The input is each text record from Step 3, including the title text and body text.

The server runs a language processing pipeline that segments the text into sentences, tokenizes each sentence into words or subwords, assigns part-of-speech tags, and identifies phrase boundaries. The server generates intermediate data structures such as token lists and phrase lists associated with each document identifier.

The output is an enriched text record that includes the original text plus token sequences and phrase segmentations.

### Step 5:

The server generates topic classification information and relevance evaluation information for each enriched text record.

The input is the enriched text record from Step 4, including token sequences and phrase segmentations.

The server applies a classification model to compute a probability distribution over predefined topic labels, assigns topic classification information as a vector of topic scores, and calculates relevance evaluation information by combining classification outputs with statistical measures such as term frequencies or document frequencies.

The output is an annotated document record that includes topic classification information and at least one relevance score associated with each document.

### Step 6:

The server stores the annotated document records and associated attribute information in an information storage apparatus.

The input is each annotated record from Step 5, containing fields such as document identifier, natural language text, topic classification information, relevance evaluation information, source identifier, and timestamps.

The server converts each record into a storage format compatible with a database, issues insertion or update commands, and commits transactions, thereby persisting the natural language text and attribute information in tables or collections.

The output is a persistent corpus of annotated documents that can be accessed by subsequent search and indexing operations.

### Step 7:

The server constructs and maintains a full-text search index over the stored natural language text.

The input is the corpus of persisted documents in the information storage apparatus, including title and body text for each document.

The server tokenizes stored text into index terms, creates postings lists that map each term to document identifiers and positions, and writes the resulting index structures to storage so that queries based on tokens can be processed efficiently. The server periodically updates the full-text index when new documents are added or existing documents are modified.

The output is a full-text search index that supports fast lookup and ranking of documents based on token occurrences.

### Step 8:

The server constructs and maintains an attribute index over topic classification information and other attribute information.

The input is the annotated attribute values persisted in the information storage apparatus, such as topic labels, relevance evaluation scores, publication dates, and source identifiers.

The server creates mappings from attribute values or value ranges (for example, particular topics, time windows, or thresholded relevance scores) to sets of document identifiers, stores these mappings in a dedicated index structure, and updates the attribute index whenever new annotations are stored.

The output is an attribute index that enables efficient retrieval of documents matching specified topics, time conditions, or relevance constraints.

### Step 9:

The user inputs a prompt sentence via the terminal to request information.

The input is the user's natural language text typed into an input field on the terminal, such as “Please summarize the latest regulations for high-efficiency gas equipment.”, “Show me trends in energy-efficient devices for residential use.”, or “What are the recent policy changes that affect electricity tariffs?”.

The terminal collects the prompt sentence, optionally adds contextual data such as user preferences or session identifiers, and transmits this data to the server through a network connection using a communication protocol.

The output is a network request that contains the prompt sentence and reaches the server for processing.

### Step 10:

The server interprets the prompt sentence and derives structured search conditions.

The input is the prompt sentence received from the terminal in Step 9.

The server applies natural language processing to tokenize the prompt sentence, detect key phrases indicating subject matter and constraints, classify the intent of the request, and map linguistic expressions to elements such as a target field, a time condition, and keyword constraints. The server then formalizes these elements as search conditions that can be applied to the full-text and attribute indexes.

The output is a structured search condition set comprising a target field specification, a time window, one or more topic filters, and a list of query terms derived from the prompt sentence.

### Step 11:

The server retrieves candidate document data from the information storage apparatus based on the search conditions.

The input is the structured search condition set from Step 10, together with the full-text search index and attribute index constructed in Steps 7 and 8.

The server applies attribute filters using the attribute index to select documents whose topic classification information and timestamps satisfy the target field and time condition, and applies token-based queries to the full-text index using the query terms to further refine and rank the selected documents. The server combines these results and produces a ranked list of candidate documents.

The output is a collection of candidate document data objects, each associated with document identifiers, natural language text, topic scores, relevance scores, and summary or metadata fields, ordered by an initial relevance ranking.

### Step 12:

The server calculates priorities for the candidate documents and enforces a predetermined length constraint to build a context set.

The input is the ranked list of candidate documents from Step 11 and the stored relevance evaluation information and topic classification information for each document, as well as a token-length budget determined by the generative AI model's capacity.

The server computes a composite priority for each candidate document by combining stored relevance scores with similarity metrics between the prompt sentence and document content, estimates the number of tokens that each candidate's summary and key passages would contribute to the generative AI model input, and selects documents in descending priority order while tracking accumulated token counts. If including a candidate would exceed the length constraint, the server either truncates low-priority portions of the document or skips that document.

The output is a context set containing selected documents and their summary information, each prepared with text segments that fit within the total token-length budget.

### Step 13:

The server constructs the input context to be supplied to the generative AI model.

The input is the context set of selected documents from Step 12 and the original prompt sentence.

The server concatenates or otherwise structures document summaries, key excerpts, and associated metadata into a context sequence, and combines this context sequence with the prompt sentence in a format expected by the generative AI model, such as a sequence of tokens with segment markers or role annotations. The server adds control instructions specifying how the generative AI model should treat the context and respond to the prompt.

The output is a fully formed model input comprising a tokenized context sequence and a tokenized representation of the prompt sentence.

### Step 14:

The server performs inference using the generative AI model to generate an answer text.

The input is the tokenized context and prompt sentence constructed in Step 13, together with the parameterized generative AI model hosted on the server or an associated accelerator.

The server feeds the input tokens through the embedding and transformer layers of the generative AI model, computes attention scores and activation values at each layer, and iteratively produces output token distributions from which it selects tokens according to configured decoding parameters. The server continues generation until reaching an end condition such as a stop token or a maximum length.

The output is an answer text, represented as a sequence of output tokens, which the server decodes into a natural language string.

### Step 15:

The server formats and transmits the generated answer text to the terminal.

The input is the raw answer text produced in Step 14 and any associated metadata such as identifiers of the documents used in the context.

The server applies formatting rules, such as inserting paragraph breaks or bullet markers, optionally attaches references to the most influential source documents, and encapsulates the answer text and metadata in a response structure. The server then sends this response structure as a network message addressed to the terminal that issued the original prompt sentence.

The output is a network response that carries the formatted answer text from the server to the terminal.

### Step 16:

The terminal receives and displays the answer text to the user.

The input is the network response from Step 15 containing the answer text and optional metadata.

The terminal parses the response, extracts the answer text, updates its user interface to show the answer in a display area, and may present additional controls such as links to source information or buttons for follow-up queries. The terminal thus renders the generated answer in a human-readable form.

The output is a visual or auditory presentation of the answer text to the user, enabling the user to read and, if desired, submit another prompt sentence.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advisor systems in technical domains such as energy management typically treat (i) natural-language interaction, (ii) database lookup, and (iii) control of external devices as separate, weakly-coupled modules. A conventional server generally receives a user query, performs a keyword-based search in a database, and returns static results. Such architectures exhibit multiple technical shortcomings.

First, a conventional server does not construct or manage rich context around a user query. Image data from user devices, structured equipment data from databases, and user state information such as emotional state or urgency are usually processed in isolation. As a result, the server cannot generate input to downstream models that fully reflects the user's situation. This leads to suboptimal utilization of processing resources: generative models may be invoked with under-specified or noisy prompts, causing unstable response quality, unnecessary token consumption, and repeated round trips.

Second, conventional systems lack a mechanism to dynamically adapt processing priority and response style based on real-time emotion evaluation. When multiple requests compete for limited processing or expert attention, traditional queueing is typically first-in-first-out or rule-based without considering emotion or urgency. This leads to inefficient allocation of computational and communication resources, increased latency for time-sensitive queries, and degraded user-perceived responsiveness, particularly in scenarios where urgent issues must be resolved quickly.

Third, existing systems do not effectively integrate multi-modal inputs (such as images and text) into a single, optimized processing pipeline. For example, an image-recognition module may identify a piece of equipment, but this result is not consistently combined with user text and retrieved knowledge into a single prompt for a generative model. This fragmented architecture prevents the server from generating high-quality, context-aware responses and from coordinating downstream device operations (such as visualization on augmented reality displays or control of external apparatus) in a unified manner. Consequently, the overall computing process exhibits redundant computation, poor cache locality, and unnecessary network traffic between modules.

Fourth, many systems fail to leverage interaction histories in a structured way to improve future computational behavior. While logs may exist, they are often stored as raw text without linking prompt content, emotional labels, retrieved data, and generated responses in a machine-usable format. Therefore, the server cannot systematically refine search strategies, adjust prompt construction logic for generative models, or optimize resource scheduling based on past performance.

Accordingly, there is a need for an improved computer system and processing method in which a processor (i) jointly manages user prompt sentences, multi-modal context, and emotion/urgency metadata, (ii) automatically constructs extended prompts for generative AI models, (iii) integrates database retrieval and machine learning outputs into a unified control flow, and (iv) records and reuses rich interaction histories to optimize subsequent processing. Such improvements would enhance the technical performance of the server itself, including response quality, processing efficiency, latency characteristics, and the effectiveness of resource allocation.

The specific processing by the specific processing unit 290 of the data processing device 12 in Application Example 2 is realized by the following means.

The present invention provides a server comprising a processor configured to analyze a prompt sentence input by a user via an information apparatus using a generative AI model, to generate dialogue control information based on an intention and a request content included in the prompt sentence, to analyze image data using image processing to identify target equipment or apparatus and to acquire corresponding information from a storage or an external information source, to organize and transform acquired information by the generative AI model into response information formatted for presentation, to analyze sentence data obtained from user text or voice input by natural language processing to evaluate an emotional state or an urgency and to control at least one of a processing priority and a response expression style based on the evaluation, to generate an extended prompt sentence for input to the generative AI model based on context information including the emotional state, the identified equipment or apparatus, and the acquired information and to obtain response information from the generative AI model based on the extended prompt sentence, to cause output of at least one of augmented reality display, dialogue screen display, and operation instruction output to a control apparatus based on at least one of the response information and control parameters, and to record, as history data, at least the prompt sentence, the emotional state, the acquired information, and the response information and to improve at least one of a subsequent prompt sentence supplied to the generative AI model and a search process by using the history data. This enables the server to perform a technically improved end-to-end processing pipeline in which multi-modal user inputs, emotion-aware prioritization, database retrieval, and generative model invocation are orchestrated in a unified manner, thereby reducing latency, improving response relevance and stability, optimizing use of computing and communication resources, and adaptively refining future processing behavior based on accumulated interaction histories.

The term “system” refers to an integrated combination of hardware and software components including at least one processor, one or more storage units, and one or more communication interfaces configured to execute the claimed processing.

The term “processor” refers to an electronic data processing unit, such as a central processing unit or a specialized processing circuit, that executes instructions to perform logical operations, numerical computations, and control flows described in the present disclosure.

The term “information apparatus” refers to an electronic device operated by a user, such as a terminal, client device, or user equipment, that provides input to the system and receives output from the system through a communication network.

The term “prompt sentence” refers to a text string or textual representation of a user instruction or query that is input by the user and supplied to the system for analysis and processing.

The term “generative AI model” refers to a trained computational model that generates output data, including text or structured information, based on input data such as a prompt sentence, using machine learning or neural network techniques.

The term “dialogue control information” refers to control data that defines or influences the flow, content, timing, or style of interaction between the user and at least one of a knowledge holder and an automated response module.

The term “knowledge holder” refers to a human expert or an automated knowledge source that provides specialized information or advice in response to a user request.

The term “image data” refers to digital data representing a visual scene, such as a still image or a frame extracted from a moving image, that is captured by an imaging device and transmitted to the system.

The term “image processing” refers to computational techniques for analyzing image data, including at least one of object detection, classification, feature extraction, segmentation, and recognition.

The term “equipment” refers to a physical device used in an installation or operation, including but not limited to machinery, appliances, and industrial devices.

The term “apparatus” refers to a physical article that performs a particular function or set of functions, including but not limited to instruments, machines, and control units.

The term “storage” refers to a data storage resource, such as a memory unit or a database system, that stores information used or generated by the system.

The term “external information source” refers to a data-providing system outside the system, such as an external database, a web service, or an application programming interface, that can be accessed by the system over a communication network.

The term “energy efficiency information” refers to data describing the relationship between energy consumption and performance of equipment or processes, including metrics, ratings, and parameters indicative of efficient energy use.

The term “case information” refers to data describing specific instances of operations or projects, including conditions, actions, and outcomes, that can serve as examples or references for later analysis.

The term “operation method information” refers to data representing recommended or actual procedures, steps, or configurations for operating equipment or performing processes.

The term “response information” refers to information generated by the system and intended to be presented to the user, including explanations, recommendations, summaries, control instructions, and other output content.

The term “sentence data” refers to textual data composed of one or more sentences obtained from user input, including transcribed voice input and directly typed text input.

The term “natural language processing” refers to computational techniques for analyzing and processing human language, including at least tokenization, part-of-speech tagging, parsing, semantic analysis, and sentiment analysis.

The term “emotional state” refers to an estimated mental or affective condition of the user, such as anxiety, satisfaction, confusion, or relief, inferred from user input or related signals.

The term “urgency” refers to a level indicating how quickly a particular user request or situation should be addressed, as determined from user input or context.

The term “processing priority” refers to an order or level assigned to processing tasks or user requests that determines relative scheduling or allocation of computational and communication resources.

The term “expression style” refers to characteristics of output information, including tone, level of detail, technical depth, politeness, and structure, used when presenting a response to the user.

The term “context information” refers to data describing circumstances related to a user request, including at least the user's emotional state, identified equipment or apparatus, previously acquired information, and session history.

The term “extended prompt sentence” refers to a prompt sentence generated or augmented by the system that combines an original user prompt with additional context information before being supplied to the generative AI model.

The term “augmented reality display” refers to a presentation format in which visual information generated by the system is superimposed onto a view of a real environment on a display device.

The term “dialogue screen display” refers to a user interface screen that presents conversational exchanges between the user and at least one of the system and the knowledge holder.

The term “control apparatus” refers to a device or subsystem configured to receive operation instructions from the system and to control at least one piece of equipment or a process based on those instructions.

The term “control parameter” refers to a value or set of values used to configure or adjust the operation of equipment, a process, or a control apparatus.

The term “history data” refers to stored data that records past interactions, including prompt sentences, emotional states, acquired information, generated responses, and related metadata.

The term “search process” refers to a computational procedure by which the system retrieves information from storage or an external information source based on one or more search conditions.

The term “analysis target data” refers to combined data generated by the system for analysis, including at least user-related operational data and reference data such as case data or operation method data.

The term “energy usage data” refers to data indicating amounts or patterns of energy consumption associated with equipment, facilities, or processes.

The term “equipment operation data” refers to data describing operational states or behaviors of equipment, such as on/off states, output levels, cycle times, or fault events.

The term “process data” refers to data indicating conditions, sequences, or performance metrics of industrial, commercial, or other operational processes.

The term “case data” refers to structured representations of case information, including descriptors of situations, actions, and outcomes suitable for computational analysis.

The term “operation method data” refers to structured representations of operation method information, including procedural steps, configuration settings, and constraints.

The term “machine learning model” refers to a trained computational model that infers patterns or predictions from input data based on machine learning algorithms, including but not limited to regression models, classification models, and neural networks.

The term “advice information” refers to output information including suggested operation patterns, setting values, or improvement proposals that are generated for the purpose of guiding configuration or operation.

The term “operation pattern” refers to a defined sequence or strategy of operations for equipment or processes, including timing, order, and parameter changes.

The term “setting value” refers to a numerical or categorical configuration parameter that influences the behavior of equipment, software modules, or control logic.

The term “improvement proposal” refers to a suggested change to an operation, configuration, or process intended to improve a performance metric such as energy efficiency.

In one embodiment, a server cooperates with at least one terminal operated by a user to implement the claimed system. The server includes at least one processor, a main memory, a non-volatile storage device, and a communication interface. The terminal includes an input device such as a keyboard, a pointing device, a microphone, a camera, and a display device such as a flat panel display or a head-mounted display. The server and the terminal are interconnected via a communication network, such as a local area network or a wide area network.

The server executes an operating system and a collection of software modules stored in the non-volatile storage device and loaded into the main memory. The software modules include at least a web application framework, an application programming interface handler, a natural language processing module, an image processing module, a generative AI model interface module, a machine learning module, a database management module, an emotion analysis module, and a user interface generation module. The server may implement the web application framework using a general-purpose framework such as a Python-based web framework or a JavaScript-based web framework. The server may implement the database management module using a relational database management system such as a structured query language database.

The terminal executes a client-side application that may be implemented as a web browser, a mobile application, or dedicated control software. The terminal captures user input including prompt sentences, images, and voice utterances, and transmits those data to the server via the communication interface. The terminal displays response information received from the server in various formats, including a dialog screen, an augmented reality overlay, and a control status screen.

The server analyzes a prompt sentence input by the user via the terminal by using a generative AI model. The generative AI model is implemented as a neural network having a plurality of transformer layers including multi-head self-attention sub-layers and feed-forward sub-layers. The server stores trained model parameters, including weight matrices and bias vectors, in the non-volatile storage device. The server loads the model parameters into the main memory and performs numerical computation using a processor such as a central processing unit or a graphics processing unit.

The server converts the prompt sentence into a token sequence by using a tokenizer, and then maps each token to a corresponding embedding vector. The server applies positional encoding and feeds the resulting sequence of embeddings to the transformer layers. The server obtains an output sequence of hidden vectors and generates a probability distribution over a vocabulary for each output position. The server selects tokens based on the probability distribution by using a decoding algorithm such as greedy decoding or beam search and constructs generated text. By performing this operation on the server side, the system can exploit optimized numerical libraries and parallel computation hardware to reduce latency and improve throughput relative to naive text processing.

The server generates dialogue control information based on an intention and a request content included in the prompt sentence. The server identifies the intention by applying a classifier constructed using machine learning techniques, such as a softmax classifier operating on a pooled representation of the hidden vectors output from the transformer layers. The server maps the classified intention to an internal dialogue state and updates a dialogue state machine stored in memory. The dialogue control information specifies, for example, whether the server should perform a database search, call a machine learning model, request human expert intervention, or directly generate a natural language response.

The server analyzes image data transmitted from the terminal by using image processing. The image processing module decodes compressed image data into an array of pixel values represented as numerical tensors. The server resizes the image to a predetermined resolution and normalizes pixel values. The server inputs the normalized image tensor into a convolutional neural network trained to identify equipment and apparatus classes. The convolutional neural network includes multiple convolution layers, pooling layers, and fully-connected layers. The server computes feature maps by convolving the image tensor with learned filters, applies non-linear activation functions, and performs pooling operations to reduce spatial dimensions. The server finally computes class scores by applying fully-connected layers and a softmax function.

The server identifies a target equipment or apparatus based on the class scores. The server associates the class with an equipment identifier stored in the database. The server then queries the database for information relating to the identified equipment or apparatus, such as technical specifications, energy efficiency ratings, and operating instructions. The server may also contact an external information source via an application programming interface to obtain additional data, such as updated industry standards or recent field data.

The server organizes and transforms acquired information by using the generative AI model. The server constructs a structured context object that includes the prompt sentence, the identified equipment identifier, the retrieved equipment information, and any relevant historical interaction data. The server converts the structured context into a text-based extended prompt sentence. For example, the server may generate a composite prompt such as:

“User prompt: ‘Please tell me how to reduce my electricity bill.’ Equipment context: residential electricity usage, high consumption at peak hours, air conditioning and lighting as major loads.

Task: Provide three concrete, technically sound recommendations to reduce electricity usage and explain the expected impact of each recommendation in simple language.”

The server inputs the extended prompt sentence to the generative AI model using the tokenization and inference procedure described above. The server thereby causes the generative AI model to generate response information that incorporates both the original prompt sentence and equipment-specific data, reducing the need for repeated network round trips and improving output relevance and stability.

The server analyzes sentence data obtained from user text or voice input by using natural language processing to evaluate an emotional state or an urgency of the user. The server segments the text into tokens, labels each token with a part-of-speech tag, and computes sentiment scores using a sentiment classifier trained on labeled text data. The sentiment classifier may be implemented as a neural network, such as a recurrent neural network, a convolutional neural network for text, or a transformer-based classifier fine-tuned on sentiment analysis data. The server outputs an emotional state label such as “anxious,” “calm,” or “confused,” together with a numerical confidence score.

The server also evaluates urgency by applying rule-based logic and statistical models to detect terms such as “urgent,” “immediately,” or “in a hurry” and to consider contextual cues such as repeated prompts without resolution. The server assigns a priority value to each user request based on the emotional state and urgency score. The server stores this priority value in association with the prompt sentence in the database and uses it to schedule processing tasks and to order dispatch of prompts to human experts when necessary.

The server controls at least one of a processing priority and a response expression style based on the evaluation result. When the emotional state indicates high stress or confusion, the server configures the generative AI model interface to request shorter, clearer answers, to avoid excessive technical jargon, and to include explicit reassurance. These configurations are encoded as parameters appended to the extended prompt sentence or as metadata that influence the decoding strategy. By dynamically controlling processing priority and expression style, the server improves perceived responsiveness and reduces the number of follow-up queries, thereby optimizing use of network and computation resources.

The server generates an extended prompt sentence based on context information including the emotional state, the identified equipment or apparatus, and the acquired information. The server uses a specialized prompt construction module that implements a template-based and rule-based combination algorithm. The prompt construction module selects template segments from a library of sentence patterns based on the identified intention, equipment type, and emotional state. The module fills slots in the template with retrieved numerical values and textual descriptions from the database. For example, when the user views a refrigerator, the server may generate an extended prompt sentence such as:

“User prompt: ‘Please tell me about this refrigerator.’ Equipment: refrigerator model group, annual power consumption approximately 200 kWh, complies with current energy efficiency standard.

User state: user is in a hurry and anxious.

Task: Summarize the key energy efficiency advantages of this refrigerator in no more than three short sentences, focusing on quick decision-making.”

The server inputs this extended prompt sentence to the generative AI model and thereby obtains response information that is specifically conditioned on both the technical context and the emotional context. This non-conventional prompt construction method differs from a simple repetition of user text and permits the server to systematically control model behavior in a way that improves computing efficiency and accuracy.

The server uses the response information and, where applicable, control parameters obtained from the database or the machine learning module to cause output to the terminal. When the terminal is a head-mounted display, the server sends structured overlay data specifying text strings, icons, and positional information relative to the detected equipment in the image. The terminal renders the overlay in an augmented reality display. When the terminal is a graphical user interface for process control, the server sends operation instruction parameters such as setpoints, timing parameters, and motion patterns. The terminal writes these parameters to a controller of an apparatus such as an industrial robot or a programmable logic controller. By directly coupling the response information to control parameters, the system enables technical control of real-world equipment in a closed loop.

The server records, as history data, at least the prompt sentence, the emotional state, the acquired information, and the response information. The server stores history data in a structured format in the database, for example as relational tables linking session identifiers, time stamps, user identifiers, emotional state labels, equipment identifiers, retrieval query identifiers, and generative model outputs. The server periodically analyzes the history data using the machine learning module to adjust prompt construction rules, update intention classifiers, and refine priority scheduling policies. This feedback mechanism allows the server to improve subsequent prompt sentences supplied to the generative AI model and to optimize search processes, resulting in improved system performance over time.

The server implements the machine learning module as a set of training and inference components. During training, the server reads labeled training data from the storage, including pairs of input context and target labels such as emotion categories, intention categories, or optimal operation patterns. The server computes a loss function such as cross-entropy loss for classification or mean squared error for regression. The server updates model parameters using an optimization algorithm such as stochastic gradient descent or an adaptive gradient method. The server may perform data augmentation, such as random cropping and rotation for image data or synonym replacement and word dropout for text data, to increase robustness. By performing these internal training and updating procedures, the server maintains models that are better adapted to the actual operating conditions of the system, thereby improving prediction accuracy and reducing error rates in downstream processing.

The server processes energy usage data, equipment operation data, and process data associated with the user and combines them with case data and operation method data stored in the storage to generate analysis target data. The server constructs multidimensional feature vectors that include numerical values such as power consumption, operating times, throughput, and error counts, as well as categorical variables such as equipment type and operating mode. The server inputs these feature vectors to a machine learning model, such as a feed-forward neural network or a gradient boosting model, to predict energy consumption or to estimate the effect of parameter changes. The server then uses the generative AI model to translate numerical optimization results into natural language advice information, including operation patterns, setting values, and improvement proposals. This architecture allows the server to perform non-trivial computations that go beyond simple human-style reasoning and uses algorithmic search over parameter spaces to generate technically grounded advice.

The system provides technical advantages beyond a mere automation of human advisory tasks. The server performs coordinated optimization of network calls, database access, and model invocation by using the dialogue control information and priority scheduling based on emotional state. By constructing extended prompt sentences that integrate multi-modal context and by filtering and structuring data before generative model invocation, the server reduces the number of tokens processed by the generative model and eliminates redundant queries. This reduction in processed data volume leads to lower memory usage, fewer cache misses, and shorter end-to-end latency.

The server also improves technical reliability by cross-validating generative outputs against database records and applying rule-based constraints. For example, when the generative AI model outputs a recommended annual consumption value, the server compares that value with database values for the identified equipment and adjusts the content if the deviation exceeds a threshold. This hybrid approach combines generative modeling with deterministic checks and thus reduces the risk of erroneous or inconsistent outputs. The effect is a reduction in output error rates and an improvement in stability of system behavior.

In another embodiment, the server uses different architectures for the generative AI model and the classifier models. The generative AI model may implement a deep transformer network with dozens of layers, while the emotion classifier may use a smaller transformer fine-tuned on domain-specific data. This separation allows the server to execute the emotion classifier faster and more frequently, including on partial user input while the user is still typing, thereby allowing earlier prioritization and faster reaction to urgent situations without incurring the heavy computation cost of a full generative inference at each keystroke.

In another embodiment, the terminal includes an eye tracking module and a gaze estimation algorithm. The terminal computes a gaze ray and intersects it with a 3D reconstruction or with a 2D bounding box of detected objects in the camera image to determine a target equipment. The server receives the target equipment identifier and uses it as part of the context information in the extended prompt sentence. By offloading initial gaze estimation to the terminal and using the server for heavier image recognition and generative processing, the system can reduce communication load and server-side computational overhead, while still maintaining high recognition accuracy.

In another embodiment, the terminal is installed in an industrial facility and is connected to multiple pieces of equipment via a fieldbus or an industrial Ethernet network. The server computes optimized operation patterns and control parameters based on the analysis target data and transmits machine-readable control instructions to the terminal. The terminal converts these instructions into protocol-specific messages for each piece of equipment. The feedback from the equipment, such as measured energy usage and cycle times, is transmitted back to the server, which uses the feedback to update the machine learning models. This closed-loop control scheme provides a direct technical effect on physical processes by reducing energy consumption and improving throughput.

In yet another embodiment, the server operates in a distributed environment where multiple servers share model parameters and database contents. The server uses caching mechanisms and sharding strategies to ensure that frequently accessed case data and operation method data are available with low latency. The server may maintain a cache of recent extended prompt sentences and corresponding generative model outputs, and re-use them when similar prompt sentences and contexts are observed, with minor modifications. This caching reduces the number of expensive generative model invocations and thus improves computational efficiency.

Overall, the described system uses a combination of specific data structures, neural network architectures, feature extraction methods, and control logic to realize a technically improved computing pipeline. The server does not merely execute business rules but instead implements specialized algorithms for prompt construction, multi-modal integration, emotion-aware scheduling, and hybrid generative-deterministic response generation. These algorithms produce technical effects including faster processing, higher output accuracy, more efficient use of hardware resources, and better alignment between computational behavior and external device control.

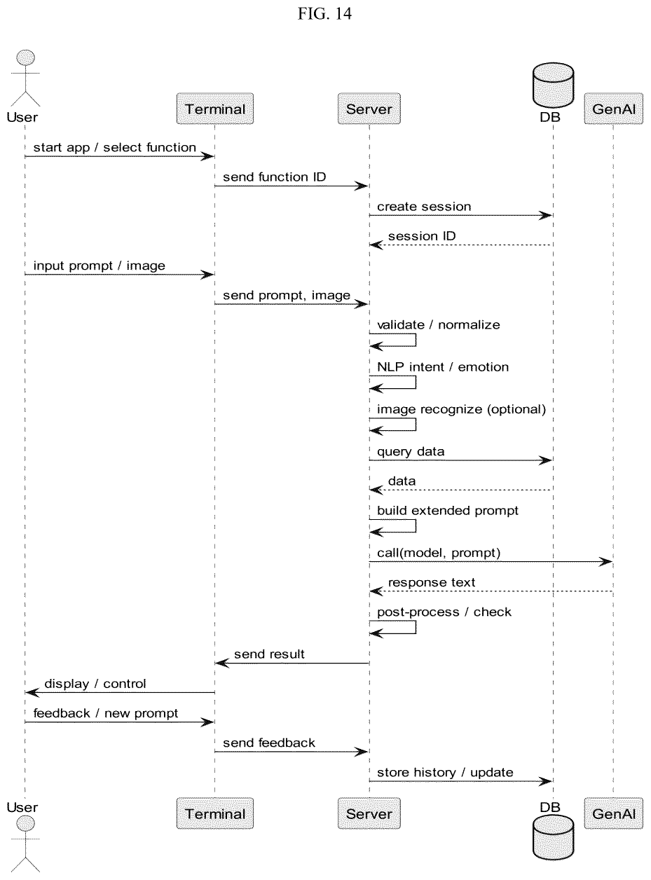

The following describes the processing flow using FIG. 14.

### Step 1:

User operates the terminal to start an application and select a function.

User views a menu such as “equipment support,” “energy advice,” or “process optimization” and selects one item.

Input: user's selection operation (for example, button click or menu tap).

Output: function identifier and user identifier transmitted from the terminal to the server.

Terminal packages the function identifier and user identifier in a request message and sends the message to the server via a network connection.

### Step 2:

Server receives the function identifier and initializes context for the user session.

Server creates a session record in a storage, assigns a session identifier, and associates the function identifier with the session identifier and the user identifier.

Input: function identifier and user identifier received from the terminal.

Output: session identifier and initial context data stored in the storage.

Server writes a record including timestamps, initial state flags, and default priority values to a database table.

### Step 3:

User inputs a prompt sentence, an image, and optionally voice data via the terminal.

User types a natural-language text such as “Please tell me how to reduce my electricity bill” or “Propose the optimal robot motion pattern to improve energy efficiency. Current product line is A.”

User may also point the camera at a piece of equipment and capture an image.

Input: user keystrokes, touch operations, camera activation, and microphone activation.

Output: prompt sentence text, image data, and audio data stored temporarily on the terminal.

### Step 4:

Terminal preprocesses local input and sends structured data to the server.

Terminal encodes the prompt sentence as a character string, encodes the image as compressed image data, and, when audio is present, sends audio data to a speech recognition service and receives transcription text.

Input: raw prompt sentence text, raw image pixels from the camera, and audio waveforms from the microphone.

Output: a request payload containing the prompt sentence, an optional equipment image, an optional transcribed prompt sentence from voice, and metadata such as timestamps and session identifier.

Terminal transmits this payload to the server using a communication protocol.

### Step 5:

Server receives the payload and performs validation and normalization.

Server checks authentication tokens, verifies payload size limits, and converts character encodings to a unified encoding.

Input: request payload including prompt sentence, optional image, and metadata.

Output: normalized text string, normalized image tensor (if present), and a validated request object.

Server logs the request object in a log storage to support later analysis.

### Step 6:

Server analyzes the prompt sentence to extract intent and keywords.

Server tokenizes the prompt sentence, converts tokens to lower case, and removes stopwords.

Server computes token frequencies or vector embeddings and applies a classifier model to infer an intent such as “information request,” “optimization request,” or “control request.”

Input: normalized prompt sentence text.

Output: intent label, keyword list, and an embedding vector representing semantic content.

Server stores the intent label and keywords in a session context record.

### Step 7:

Server performs emotion and urgency analysis based on the prompt sentence.

Server feeds the tokenized sentence into an emotion classifier model and calculates scores for emotions such as “anxious,” “calm,” or “confused.”

Server also checks for urgency markers such as “urgent,” “in a hurry,” or “immediately.”

Input: tokenized prompt sentence and embedding vector.

Output: emotional state label, urgency score, and a priority value derived from these scores.

Server writes the emotional state and urgency score to the database and updates the session priority.

### Step 8:

Server optionally performs image analysis to identify equipment or apparatus.

Server decodes the image data, resizes it, normalizes pixel values, and inputs the image tensor into an image recognition model.

Server computes class probabilities and selects a class corresponding to a type of equipment.

Input: normalized image tensor representing equipment or an environment.

Output: equipment identifier, classification confidence score, and an equipment type label.

Server associates the equipment identifier with the session and writes a mapping record to the storage.

### Step 9:

Server queries internal and external data sources based on intent, keywords, and identified equipment.

Server constructs a query containing keywords and the equipment identifier and sends the query to a database engine.

Server optionally sends a request to an external information source to obtain the latest technical or energy-related data.

Input: intent label, keyword list, equipment identifier, and user profile data.

Output: structured information records such as equipment specifications, energy usage statistics, success cases, and operation methods.

Server merges these records into a context data structure and removes duplicate or obsolete entries.

### Step 10:

Server constructs an extended prompt sentence for a generative AI model.

Server selects a template according to the intent and context and fills template slots with retrieved data, emotional state, and equipment information.

Server concatenates the original prompt sentence with explanatory context and task instructions.

Input: original prompt sentence, structured information records, emotional state label, and equipment identifier.

Output: extended prompt sentence text tailored for the generative AI model.

Server stores the extended prompt sentence along with a reference to the session in the storage.

### Step 11:

Server invokes the generative AI model with the extended prompt sentence.

Server tokenizes the extended prompt sentence, converts tokens to embeddings, and performs forward propagation through multiple transformer layers to produce output logits.

Server applies a decoding strategy, such as beam search with specified parameters, to generate output tokens representing response text.

Input: extended prompt sentence and generative AI model parameters.

Output: generated response text containing explanations, recommendations, or operation patterns.

Server may additionally compute a confidence score or other metrics associated with the generated text.

### Step 12:

Server post-processes the generated response and applies consistency checks.

Server scans the generated response for numerical values related to energy consumption or equipment parameters and cross-references them against database records.

Server adjusts or annotates values when deviations exceed predefined thresholds.

Input: generated response text and reference data from the database.

Output: corrected or annotated response text that satisfies consistency rules.

Server also truncates or formats the response for specific display types, such as short overlays for augmented reality.

### Step 13:

Server decides the output modality and prepares presentation data.

Server examines the function identifier, terminal type, and user context to determine if the response should be delivered as a chat, an augmented reality overlay, or machine-readable control parameters.

Input: corrected response text, session context, and terminal capability information.

Output: presentation data structures such as chat messages, overlay descriptors, or control parameters.

Server creates a payload that includes text segments, icons, positional hints, or parameter values for external devices.

### Step 14:

Terminal receives the presentation data and renders visual output or applies control.

Terminal updates a chat interface with the response text, superimposes overlay text near an identified equipment in a camera view, or sends control parameters to a control unit.

Input: presentation data received from the server.

Output: visible information on a display device or modified configuration on a controlled apparatus.

Terminal may also log the displayed or applied result locally for diagnostic purposes.

### Step 15:

User reviews the output and optionally provides feedback or follow-up prompts.

User reads the explanation, observes the augmented reality overlay, or confirms changes to equipment settings.

User may then input additional prompt sentences such as “Explain this in simpler terms,” or “Adjust the motion pattern to reduce speed further.”

Input: displayed information and any operational changes noticed by the user.

Output: new prompt sentence, confirmation operations, or rejection actions captured by the terminal.

Terminal sends new input back to the server, allowing refinement or continuation of the interaction.

### Step 16:

Server records history data and updates models and rules over time.

Server stores associations among prompt sentences, emotional states, retrieved data, extended prompt sentences, generated responses, and outcomes such as user acceptance or rejection.

Server periodically uses this history to retrain classifiers, adjust prompt construction rules, and refine scheduling strategies.

Input: logged session data, including user inputs, model outputs, and interaction results.

Output: updated model parameters, updated rule sets, and improved configuration values stored in the system.

Server thereby enhances future processing accuracy, reduces response times, and improves the allocation of computational and communication resources.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

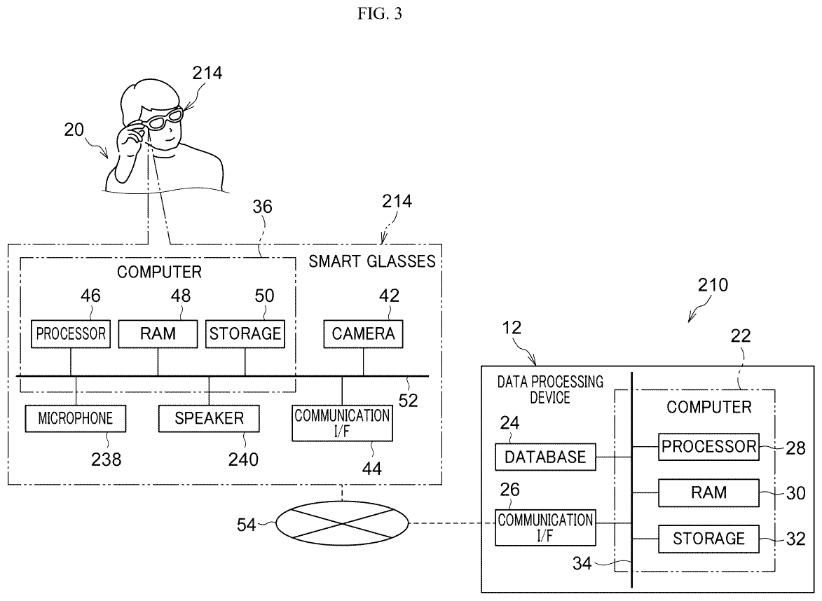

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

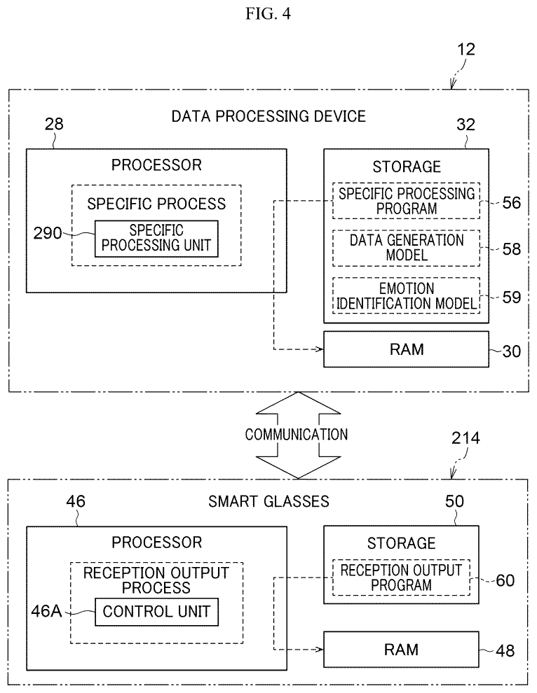

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

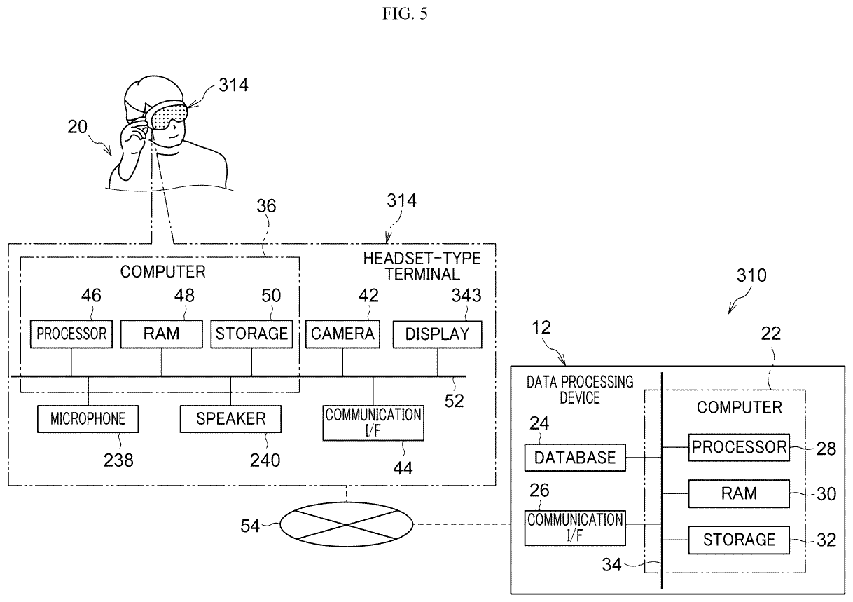

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

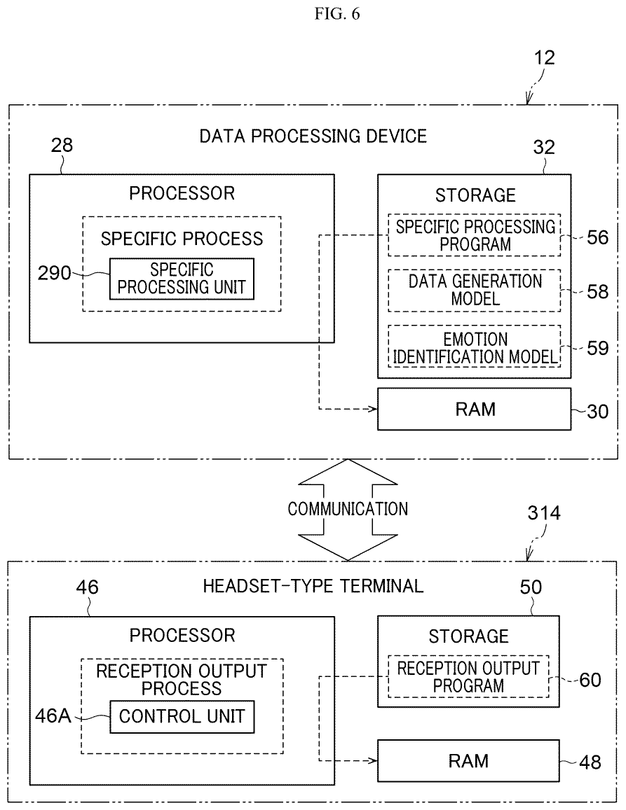

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

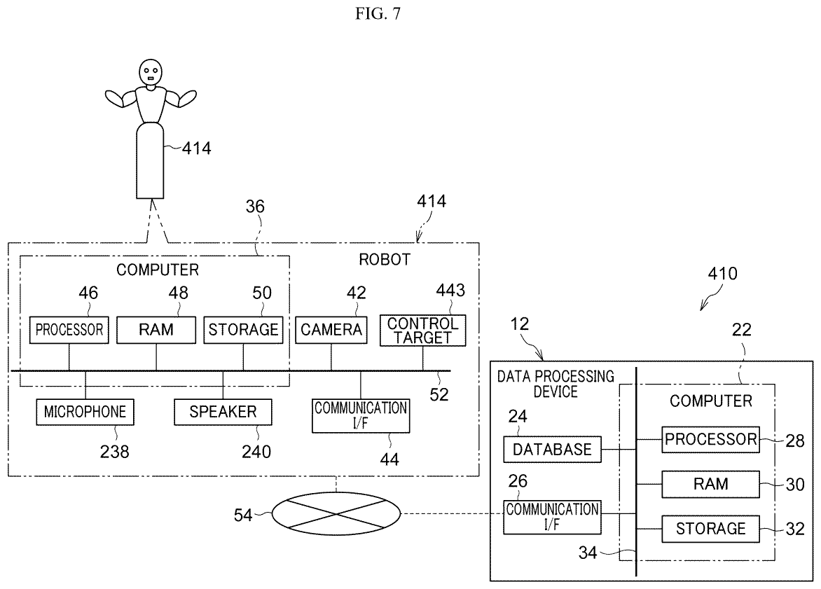

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

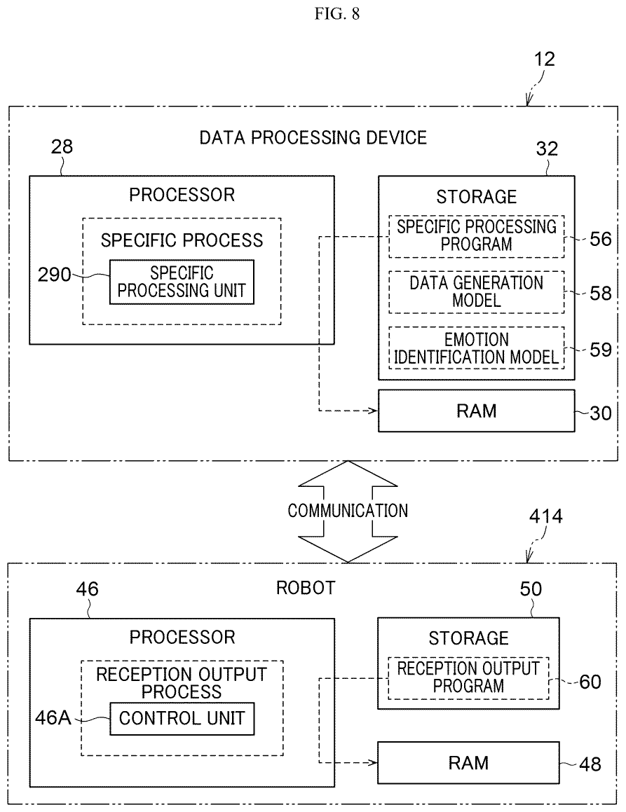

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

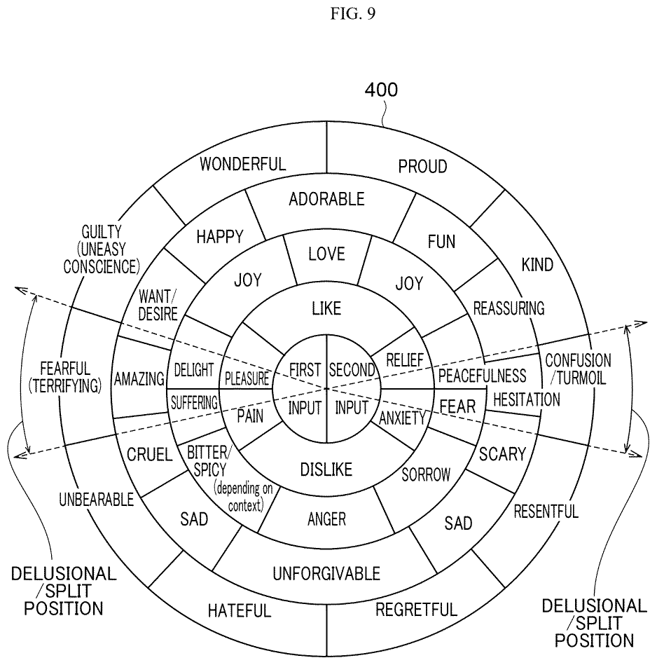

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

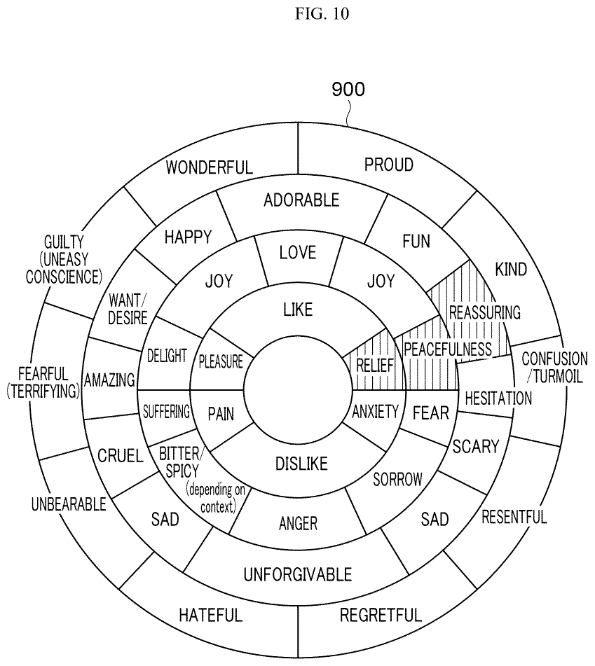

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from a user terminal, a natural-language prompt sentence, analyze the prompt sentence to extract user identification information, conversation identification information, and text information corresponding to inquiry content, and store the text information in a data storage device, and
apply natural language processing to the text information to extract keyword information and topic information, search the data storage device storing expert information based on the keyword information and the topic information, and identify an expert related to the inquiry content, and
establish, between the user terminal and an expert terminal of the identified expert, a communication path that enables real-time transmission and reception of message information, transmit inquiry text information acquired from the user terminal to the expert terminal, and transmit answer text information acquired from the expert terminal to the user terminal without delay, and
generate a prompt sentence based on the answer text information acquired from the expert terminal and conversation history information related to the answer text information, input the prompt sentence into a generative AI model, and cause the generative AI model to generate supplemental information that complements the answer text information, and
store, in association with the conversation identification information, the supplemental information output from the generative AI model in the data storage device, and transmit the supplemental information to the user terminal so that the supplemental information is displayed together with the answer text information, and
acquire log information regarding transmission and reception processing of the message information and the supplemental information between the user terminal and the expert terminal, and update an expert selection condition and a prompt sentence generation condition based on the log information.

### (Supplementary 2)

The system according to supplementary 1,
wherein the processor is configured to
analyze, by using natural language processing, emotion-state estimation text information acquired from the user terminal to estimate emotion-state information, and add conversation-context information including the emotion-state information to the prompt sentence input into the generative AI model so as to cause the generative AI model to generate the supplemental information in accordance with a user emotion state.

### (Supplementary 3)

The system according to supplementary 1,
wherein the processor is configured to
include energy usage situation data, past expert answer history data, and past supplemental information data in the prompt sentence input into the generative AI model, and cause the generative AI model to generate, as the supplemental information, energy-saving action proposal information that integrates an analysis result based on the energy usage situation data and advice from the expert.

### Application Example 1

### (Supplementary 1)

A system comprising a processor,
wherein the processor is configured to
store energy usage information received from a user terminal in association with historical information stored in a storage device, and execute aggregation processing and statistical processing based on time-series information and attribute information, and determine an abnormal state of energy usage by comparing a reference value and a current value, generate, when the abnormal state is determined, analysis result information including facility identification information, time range information, energy usage increase ratio information, and equipment type information, generate a prompt sentence from the analysis result information, and input the prompt sentence and the analysis result information to a generative AI model to cause the generative AI model to generate advice information on energy management in natural language, add, to the generative AI model, a control prompt sentence including domain information and conversation policy information to set dialogue generation conditions, and generate conversation support information configured to facilitate a dialogue between a user and a specialist by storing the advice information on energy management together with dialogue history information,
cause a notification of the abnormal state of energy usage to be provided to the user terminal by using the advice information on energy management and the conversation support information, and output control information for launching a dialogue screen with the specialist from the notification,
cause, by providing to the generative AI model text information including a prompt sentence input from the user terminal and the dialogue history information, the generative AI model to generate a response sentence, and, as necessary, relay the text information and the response sentence between the user terminal and a specialist terminal, thereby presenting advice information to the user in real time, and
store implementation status information received from the user terminal in association with the advice information on energy management, and generate control information for updating future prompt sentences and instructions to the generative AI model based on the implementation status information and subsequent energy usage information.

### (Supplementary 2)

The system according to supplementary 1,
wherein the processor is configured to
transmit, in real time, a prompt sentence input from the user terminal to a specialist terminal,
and integrate a response sentence generated by the generative AI model and a response sentence received from the specialist terminal, and immediately return the integrated response sentence to the user terminal.

### (Supplementary 3)

The system according to supplementary 1,
wherein the processor is configured to
execute trend analysis processing and anomaly detection processing on the energy usage information stored in the storage device by using the generative AI model, and generate control information for providing the user with advice information obtained by integrating advice information from the specialist and automatically generated advice information based on a result of the trend analysis processing and the anomaly detection processing.

### Example 2

### (Supplementary 1)

A system comprising a processor,
wherein the processor is configured to
receive a prompt sentence from a user terminal and analyze the prompt sentence by using a generative AI model so as to extract an information request content, a target field, and a time condition included in the prompt sentence,
obtain standardized document data from an information providing apparatus that provides industry-related information via a communication network based on pre-stored information source identification information, remove structural information from the obtained document data to extract natural language text, execute natural language processing including morphological analysis, phrase segmentation, and important phrase extraction on the natural language text, and generate topic classification information and relevance evaluation information regarding the natural language text,
store the natural language text in an information storage apparatus together with attribute information based on the topic classification information and the relevance evaluation information, and construct a full-text search index and an attribute index for the natural language text in the information storage apparatus,
search the information storage apparatus based on search conditions corresponding to an analysis result of the prompt sentence, acquire a plurality of pieces of document data and summary information corresponding thereto that satisfy the search conditions, and construct the plurality of pieces of document data and the summary information as context for input to the generative AI model, and
input the context for input and the prompt sentence to the generative AI model, cause the generative AI model to generate an answer text based on the context and the prompt sentence, and transmit the generated answer text to the user terminal.

### (Supplementary 2)

The system according to supplementary 1,
wherein the processor is configured to, when constructing the context for input to the generative AI model, calculate a priority for each of the plurality of pieces of document data acquired from the information storage apparatus based on the relevance evaluation information, and select or divide the document data and the summary information so as to satisfy a predetermined length constraint.

### (Supplementary 3)

The system according to supplementary 1,
wherein the processor is configured to automatically execute, at predetermined time intervals, an update process for the document data to be obtained based on the information source identification information, execute the natural language processing and the generation of the topic classification information and the relevance evaluation information for newly obtained document data in the update process, and integrate the newly obtained document data with existing document data in the information storage apparatus to update the full-text search index and the attribute index.

### Application Example 2

### (Supplementary 1)

A system comprising a processor,
wherein the processor is configured to
analyze a prompt sentence input by a user via an information apparatus by using a generative AI model, and generate dialogue control information for dialogue with a knowledge holder or for automatic response based on an intention and a request content included in the prompt sentence,
analyze image data transmitted from the information apparatus by using image processing, identify a target equipment or apparatus in the image data, and acquire information relating to the identified equipment or apparatus from a storage or an external information source based on an identification result,
organize, summarize, or compare energy efficiency information, case information, or operation method information acquired from the storage or the external information source by using the generative AI model, and generate response information in a presentation format suitable for the user,
analyze sentence data obtained from text input or voice input of the user by using natural language processing, evaluate an emotional state or an urgency of the user, and control at least one of a processing priority corresponding to the prompt sentence and an expression style of a response based on an evaluation result,
generate an extended prompt sentence to be input to the generative AI model based on context information including the emotional state of the user, the identified equipment or apparatus, and the acquired information, and acquire response information from the generative AI model based on the extended prompt sentence,
cause output of at least one of augmented reality display on a display apparatus, dialogue screen display, and operation instruction output to a control apparatus based on at least one of the response information and a control parameter acquired from the storage or the external information source, and
record, as history data, at least the prompt sentence, the emotional state, the acquired information, and the response information used for generation of the response information,
and improve at least one of a subsequent prompt sentence to be supplied to the generative AI model and a search process by using the history data.

### (Supplementary 2)

The system according to supplementary 1,
wherein the processor is configured to change, in accordance with at least one of the evaluated emotional state and the evaluated urgency, at least one of an order of transmitting the prompt sentence of the user to the knowledge holder and an order of presenting a response from the knowledge holder to the user.

### (Supplementary 3)

The system according to supplementary 1,
wherein the processor is configured to generate analysis target data by combining at least one of energy usage data, equipment operation data, and process data associated with the user with at least one of case data and operation method data stored in the storage, and input the analysis target data to the generative AI model and to a machine learning model to generate advice information including at least one of an operation pattern, a setting value, and an improvement proposal for improving energy efficiency.

What is claimed is:

1. A system comprising:
circuitry configured to:
receive, via a communication interface coupled to a packet-switched network, a prompt sentence input by a user from a terminal device, and analyze the prompt sentence using a natural language processing model to extract keyword information, topic information, and inquiry content;
search a storage device storing expert information based on the keyword information and the topic information, and identify an expert related to the inquiry content;
acquire information from an external information source via the communication interface based on the keyword information and the topic information, organize the acquired information using a generative neural network model, and generate organized information for provision to the user;
analyze text input of the user using a natural language processing technique to evaluate an emotional state and an urgency of the user, and control at least one of a processing priority or a response expression style based on the evaluation; and
generate an extended prompt sentence for input to the generative neural network model based on context information comprising the emotional state, the inquiry content, and the organized information, acquire response information from the generative neural network model, and transmit the response information to the terminal device via the communication interface.

2. The system according to claim 1, wherein the circuitry is configured to analyze the prompt sentence by applying morphological analysis and intent classification to extract the keyword information and the topic information, and to generate dialogue control information specifying a processing flow for facilitating dialogue between the user and the identified expert.

3. The system according to claim 2, wherein the circuitry is configured to establish a communication session between the terminal device and an expert terminal of the identified expert via the communication interface, and to process a prompt that instructs real-time transmission of the user's inquiry to the expert and return of a response from the expert to the user.

4. The system according to claim 3, wherein the circuitry is configured to record, as history data in the storage device, at least the prompt sentence, the emotional state, the acquired information, and the response information, and to improve at least one of a subsequent prompt sentence or a search process using the history data.

5. The system according to claim 4, wherein the circuitry is configured to extract conversation identification information and user identification information from the prompt sentence, store the inquiry content in association with the conversation identification information and the user identification information in the storage device, and retrieve stored dialogue history to augment the extended prompt sentence during ongoing conversation.

6. The system according to claim 1, wherein the circuitry is configured to receive energy usage information from the terminal device, store the energy usage information in association with historical information in the storage device, execute aggregation processing and statistical processing based on time-series information and attribute information, and determine an abnormal state of energy usage by comparing a reference value and a current value.

7. The system according to claim 6, wherein the circuitry is configured to generate analysis result information comprising identification information, time range information, energy usage increase ratio information, and equipment type information upon determination of an abnormal state, and to generate a prompt sentence from the analysis result information for input to the generative neural network model to produce advice information on energy management in natural language.

8. The system according to claim 7, wherein the circuitry is configured to generate analysis target data by combining at least one of energy usage data, equipment operation data, or process data with at least one of case data or operation method data stored in the storage device, and to input the analysis target data to the generative neural network model to generate advice information comprising at least one of an operation pattern, a setting value, or an improvement proposal for improving energy efficiency.

9. The system according to claim 1, wherein the circuitry is configured to obtain standardized document data from an external information providing apparatus via the communication interface, remove structural information from the obtained document data to extract natural language text, execute natural language processing comprising at least morphological analysis, phrase segmentation, and important phrase extraction on the natural language text, and generate topic classification information and relevance evaluation information for storage in the storage device.

10. The system according to claim 9, wherein the circuitry is configured to generate a summary sentence from the natural language text using the generative neural network model, and to construct organized information by combining the summary sentence with the topic classification information and the relevance evaluation information for provision to the user.

11. The system according to claim 1, wherein the circuitry is configured to analyze image data received from the terminal device using image processing to identify target equipment or apparatus, and to acquire information corresponding to the identified equipment or apparatus from the storage device or the external information source for incorporation into the extended prompt sentence.

12. The system according to claim 11, wherein the circuitry is configured to generate the extended prompt sentence by combining at least the inquiry content, the identified equipment information, the organized information, and the evaluation result of the emotional state into a single input sequence for the generative neural network model.

13. The system according to claim 1, wherein the circuitry is configured to change, in accordance with at least one of the evaluated emotional state or the evaluated urgency, at least one of an order of transmitting the prompt sentence to the identified expert or an order of presenting a response from the identified expert to the user.

14. The system according to claim 13, wherein the circuitry is configured to classify the urgency into urgency levels based on at least one of temporal expressions, negative sentiment scores, or exclamatory linguistic patterns detected in the text input of the user, and to assign a processing priority to the inquiry content based on the classified urgency level.

15. The system according to claim 1, wherein the circuitry is configured to cause output of at least one of augmented reality display on a display apparatus, dialogue screen display, or operation instruction output to a control apparatus based on at least one of the response information or a control parameter acquired from the storage device or the external information source.

16. The system according to claim 1, wherein the circuitry is configured to perform evaluation of the response information generated by the generative neural network model based on an evaluation result, and to adjust at least one of a format of the extended prompt sentence or an expression style of the response information based on the evaluation result.

17. The system according to claim 16, wherein the circuitry is configured to store the evaluation result in the storage device as part of the history data, and to incorporate the evaluation result into a subsequent extended prompt sentence to improve quality of response information generated in subsequent processing cycles.

18. A system comprising:
circuitry configured to:
receive, via a communication interface coupled to a packet-switched network, a prompt sentence input by a user from a terminal device, and analyze the prompt sentence using a natural language processing model to extract keyword information, topic information, and inquiry content;
search a storage device based on the keyword information and the topic information to identify an expert related to the inquiry content, and establish a communication session between the terminal device and an expert terminal of the identified expert;
acquire information from an external information source via the communication interface, remove structural information from the acquired information to extract natural language text, execute natural language processing comprising morphological analysis and important phrase extraction, and generate organized information using a generative neural network model;
analyze text input of the user to evaluate an emotional state and an urgency, and control at least one of a processing priority or a response expression style based on the evaluation;
generate an extended prompt sentence comprising the inquiry content, the organized information, and the emotional state, input the extended prompt sentence to the generative neural network model to acquire response information, and transmit the response information to the terminal device; and
record at least the prompt sentence, the emotional state, the acquired information, and the response information as history data in the storage device, and improve at least one of a subsequent prompt sentence or a search process using the history data.

19. The system according to claim 18, wherein the circuitry is configured to receive energy usage information from the terminal device, determine an abnormal state of energy usage by comparing a reference value and a current value based on time-series aggregation processing,
and generate advice information on energy management in natural language by inputting analysis result information comprising identification information and energy usage increase ratio information to the generative neural network model.

20. A method comprising:
receiving, via a communication interface coupled to a packet-switched network, a prompt sentence input by a user from a terminal device, and analyzing the prompt sentence using a natural language processing model to extract keyword information, topic information, and inquiry content;
searching a storage device storing expert information based on the keyword information and the topic information, and identifying an expert related to the inquiry content;
acquiring information from an external information source via the communication interface based on the keyword information and the topic information, organizing the acquired information using a generative neural network model, and generating organized information for provision to the user;
analyzing text input of the user using a natural language processing technique to evaluate an emotional state and an urgency of the user, and controlling at least one of a processing priority or a response expression style based on the evaluation; and
generating an extended prompt sentence for input to the generative neural network model based on context information comprising the emotional state, the inquiry content, and the organized information, acquiring response information from the generative neural network model, and transmitting the response information to the terminal device via the communication interface.
